(19) United States
(12) Patent Application Publication
(10) Pub. No.: US 2023/0148609 A1
(43) Pub. Date: May 18, 2023

(54) OIL-BASED INSECTICIDAL AND INSECT REPELLENT COMPOSITIONS

(71) Applicant: S. C. Johnson & Son, Inc., Racine, WI (US)

(72) Inventor: Alexis Huckabee, Kenosha, WI (US)

(21) Appl. No.: 17/989,516

(22) Filed: Nov. 17, 2022

Related U.S. Application Data
(60) Provisional application No. 63/280,994, filed on Nov. 18, 2021.
(60) Provisional application No. 63/280,997, filed on Nov. 18, 2021.

(51) Int. Cl. A01N 65/22; A01N 65/08; A01N 65/24; A01N 65/06

(52) U.S. Cl. CPC A01N 65/22; A01N 65/08; A01N 65/24; A01N 65/06

(57) ABSTRACT

A pest control composition, the composition including an active component having between about 0.001 wt. % to about 5 wt. % spearmint oil, between about 0.01 wt. % to about 5 wt. % geranium oil, and between about 0 wt. % to about 5 wt. % of a third oil selected from the group consisting of cinnamon oil, cedarwood oil, and mixtures thereof. The composition further includes a carrier, a solvent, and a dehydrate.

### CROSS REFERENCE TO RELATED APPLICATIONS

This application is related to, claims priority to, and incorporates herein by reference for all purposes U.S. Provisional Patent Application No. 63/280,994, filed Nov. 18, 2021, and U.S. Provisional Patent Application No. 63/280,997, filed on Nov. 18, 2021.

### REFERENCE REGARDING FEDERALLY SPONSORED RESEARCH OR DEVELOPMENT

Not applicable.

### SEQUENCE LISTING

Not applicable.

### BACKGROUND

### 1. Technology Field

The present disclosure relates to a pest control composition and, more particularly, to an oil-based insecticidal composition, that includes at least one mint oil (one of spearmint and cornmint oil), and geranium oil. The present disclosure also relates to a pest control composition that includes at least one mint oil (one of spearmint, peppermint, and cornmint oil), geranium oil, and cinnamon oil. The present disclosure also relates to a pest control composition that includes at least one mint oil (one of spearmint, peppermint, and cornmint oil), geranium oil, and cedarwood oil.

### 2. Description of the Background

Pest control compositions, including insecticidal compositions have been used over the years to prevent insects from attacking humans, animals, and crops. One disadvantage of many insecticides and insect repellent compositions currently available is their unpleasant, harsh, and lingering chemical odor. In providing insecticide and insect repellent compositions with a more pleasant and less harsh odor, pest killing/repelling efficacies and/or time to achieve pest mortality are compromised due to the necessity to employ fewer, or reduced concentrations of, chemical active ingredients and inert ingredients.

Therefore, it is desirable to have a pest control composition, such as an insecticidal or an insect repellent composition that reduces the unpleasant harsh and lingering chemical odor and at the same time does not sacrifice efficacy.

### SUMMARY

Embodiments of the current disclosure describe a pest control composition, for example, an insecticidal composition and an insect repellent composition comprising (i) mint oil (e.g., spearmint oil, peppermint oil, cornmint oil, and mixtures thereof) and (ii) geranium oil. In the present disclosure, Applicant demonstrates that a combination of the mint and geranium essential oils unexpectedly provides a pleasant smell, a low linger scent, and a high efficiency of killing/repelling insects.

In an embodiment, the present disclosure provides a pest control composition that includes an active component having between about 0.001 wt. % and about 5 wt. % spearmint oil, between about 0.01 wt. % and about 5 wt. % geranium oil, and between about 0 wt. % and about 5 wt. % of a third oil selected from the group consisting of cinnamon oil, cedarwood oil, and mixtures thereof. In this embodiment, the composition further includes a carrier, a solvent, and a dehydrate, and all weight percentages are percent by weight of the total composition. Further, in all embodiments, all weight percentages are percent by weight of the total composition.

In some embodiments, the active component is between about 2 wt. % and about 6 wt. %. In further embodiments, the spearmint oil is between about 0.05 wt. % and about 2 wt. %, the geranium oil is between about 0.05 wt. % and about 2 wt. %, and the third oil is between about 0.05 wt. % and about 2 wt. %. In even further embodiments, the weight ratio of geranium oil to spearmint oil is from about 0.5:1 to about 20:1.

In other embodiments, the solvent is selected from the group consisting of ethyl lactate, butyl lactate, isopropyl alcohol, and any combinations thereof. In further embodiments, the carrier is selected from the group consisting of aliphatic C₉-C₁₄ hydrocarbons, alicyclic C₉-C₁₄ hydrocarbons, naphtha, petroleum distillate, paraffins, iso-paraffins, isoparaffinic hydrocarbons, cycloparaffins, alkanes, iso-alkanes, cycloalkanes, mineral oil, white mineral oil, and any combinations thereof. In some embodiments, the dehydrate is isopropyl myristate.

In some embodiments, the composition includes between about 8 wt. % and about 15 wt. % by weight of the dehydrate, between about 1 wt. % and about 5 wt. % of a propellant, between about 60 wt. % and about 90 wt. % of the carrier, and between about 2 wt. % and about 10 wt. % of the solvent. Additionally, in some embodiments, the propellant is selected from the group consisting of compressed gas propellants, liquefied gas propellants, saturated hydrocarbons, mixtures of liquified gas and compressed gas, methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. More so, in other embodiments, the spearmint oil is in a higher weight percentage concentration than the geranium oil.

According to another embodiment of the present disclosure, another pest control composition is provided. In this embodiment, the composition includes an active component that includes between about 0.01 wt. % to about 5 wt. % geranium oil, between about 0.001 wt. % to about 5 wt. % of at least one mint oil, and between about 0 wt. % to about 5 wt. % of a third oil selected from the group consisting of cinnamon oil, cedarwood oil, and mixtures thereof. Further, in this embodiment, the composition also includes a carrier, a solvent, and a dehydrate.

In these embodiments, the mint oil may be selected from the group consisting of spearmint oil, peppermint oil, cornmint oil, and combinations thereof. Further, in some embodiments, the composition includes between about 8 wt. % and about 15 wt. % by weight of the dehydrate, between about 1 wt. % and about 5 wt. % of a propellant, between about 60 wt. % and about 90 wt. % of the carrier, and between about 1 wt. % and about 10 wt. % of the solvent.

In other embodiments, the weight ratio of geranium oil to mint oil is from about 0.5:1 to about 20:1. In further embodiments, the carrier is selected from the group consisting of aliphatic C₉-C₁₄ hydrocarbons, alicyclic C₉-C₁₄ hydrocarbons, naphtha, petroleum distillate, paraffins, iso-paraffins, isoparaffinic hydrocarbons, cycloparaffins, alkanes, iso-alkanes, cycloalkanes, mineral oil, white mineral oil, and any combinations thereof. In other embodiments, the solvent is selected from the group consisting of ethyl lactate, butyl lactate, isopropyl alcohol, and any combinations thereof. In other embodiments, the dehydrate is isopropyl myristate. In particular embodiments, the mint oil is spearmint oil. Even further, in some embodiments, the propellant is selected from the group consisting of methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof.

According to another embodiment of the present disclosure, yet another pest control composition is provided. In this embodiment, the composition includes an active component that includes between about 0.001 wt. % and about 5 wt. % of a mint oil, between about 0.01 wt. % and about 5 wt. % geranium oil, and between about 0 wt. % and about 5 wt. % of a third oil selected from the group consisting of cinnamon oil, cedarwood oil, and mixtures thereof. Here, the mint oil is selected from the group consisting of spearmint oil, cornmint oil, and mixtures thereof. Further, the composition includes about 60 wt. % to about 90 wt. % of mineral oil, about 1 wt. % to about 10 wt. % of at least one solvent, about 8 wt. % to about 15 wt. % of at least one dehydrate, and about 1 wt. % to about 5 wt. % of at least one propellant. Further, the weight ratio of geranium oil to mint oil is from about 0.5:1 to about 20:1.

### DETAILED DESCRIPTION

The term “about” or “approx.”, as used herein, refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture. In one embodiment, the term “about” refers to a range of values+/−5% of a specified value.

The term “weight percent”, “wt. %”, “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “%”, etc.

As used herein, “pests” can mean any organism whose existence it can be desirable to control. Pests can include, for example, bacteria, cestodes, fungi, insects, nematodes, parasites, plants, and the like. In addition, as used herein, “pesticidal” can mean, for example, antibacterial, antifungal, antiparasitic, herbicidal, insecticidal, and the like.

More so, for purposes of simplicity, the term “insect” is used in this application. However, it should be understood that the term “insect” refers, not only to insects, but may also to mites, spiders, and other arachnids, larvae, and like invertebrates. As used herein, the term “insect” refers to and includes but is not limited to insects or arachnids capable of acting as vectors for disease to humans, animals, birds, fish, plants or plant parts, or capable of irritating or causing economic damage thereto. Examples include but are not limited to nematodes, biting insects (such as mosquitoes, gnats, horse flies, ticks, tsetse flies, blowfly, screw fly, bed bugs, fleas, lice and sea lice), sap-sucking insects (such as aphids and thrips) and further include arachnids, ticks, termites, silverfish, ants, cockroaches, locust, fruit flies, wasps, hornets, yellow jackets, scorpions, chiggers and mites (such as dust mites).

Embodiments of the invention can be used to control parasites. The term “parasite” encompasses numerous protozoa, helminths, and ectoparasites. Protozoa may include the ameba, flagellates, ciliates, and the sporozoa. Protozoa typically infect the blood and tissue and may be transmitted through the bite of a mosquito. Protozoa are responsible for such diseases as malaria, trypanosomiasis, leishmaniasis, toxoplasmosis, and cryptosporidiosis. Helminths are typically classified into three groups, flatworms, roundworms, and thorny-headed worms. Helminths are responsible for such diseases as enterobiasis, ascariasis, taeniasis, cysticercosis, and schistosomiasis. Ectoparasites may include mosquitoes, ticks, fleas, lice, and mites. Many ectoparasites may cause disease on their own, but are even more important as vectors of a number of different pathogens, including protozoa.

Further, for purposes of this application, the term “pest control” shall refer to having a repellent effect, a pesticidal effect, or both. “Repellent effect” is an effect wherein more insects are repelled away from a host or area that has been treated with the composition than a control host or area that has not been treated with the composition. Similarly, the term “repelling” or “repel” refers to the ability of the compositions described herein to cause a pest or insect to deviate away from or avoid a surface, object or insect breeding site treated with said composition. In some embodiments, as will be shown in the present disclosure, a repellent effect is an effect wherein at least about 75% of insects are repelled away from a host or area that has been treated with the composition. In some embodiments, however, a repellent effect is an effect wherein at least about 90% of insects are repelled away from a host or area that has been treated with the composition. In addition, “pesticidal effect” or “insecticidal effect” is an effect wherein treatment with a composition causes at least about 1% of the insects to die. In this regard, an LC1 to LC100 (lethal concentration) or an LD1 to LD100 (lethal dose) of a composition will cause a pesticidal or insecticidal effect. In some embodiments, the pesticidal effect or the insecticidal effect is an effect wherein treatment with a composition causes at least about 5% of the exposed insects to die. In some embodiments, the target pest is a non-insect, such as a parasite.

As used herein, the term “knocking down” or “knockdown” refers to the ability of the composition described herein to render an insect immobile. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease or irritate is severely curtailed during the period in which it is knocked down.

As used herein, the term “killing” or “kill” refers to the ability of at least one active ingredient in a composition to render an insect dead. As further used herein, the term “knocking down” or “knockdown” refers to the ability of the composition described herein to render an insect immobile for a pre-determined period of time. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease, or irritate is severely curtailed during the period in which it is knocked down.

In the pest control field, it is known that consumers desire a product that has a reduced unpleasant, harsh, and lingering chemical odor, without sacrificing efficacy. Therefore, it is important to develop a pest control composition, for example, an insecticidal composition and an insect repellent composition, that offer pleasant hedonics and at the same time do not compromise the insect killing/repelling efficacies. It has been found that a pest control composition comprising (i) mint oil (e.g., spearmint oil, peppermint, cornmint oil, and mixtures thereof), and (ii) geranium oil provides such benefits. Another insecticidal composition that provides similar benefits includes a pest control composition comprising (i) mint oil (e.g., spearmint oil, peppermint oil, cornmint oil), and mixtures thereof, (ii) geranium oil, and (iii) cinnamon oil. Another insecticidal composition that provides similar benefits includes a pest control composition comprising (i) mint oil (e.g., spearmint oil, peppermint oil, cornmint oil, and mixtures thereof), (ii) geranium oil, and (iii) cedarwood oil. Another insecticidal composition that provides similar benefits includes a pest control composition comprising (i) geranium oil, and (ii) a second oil selected from the group consisting of spearmint oil, cornmint oil, cinnamon oil, and mixtures thereof.

The insecticidal composition according to an embodiment of the present disclosure is a pest control composition comprising (i) mint oil selected from the group consisting of spearmint oil, cornmint oil, and mixtures thereof, and (ii) geranium oil. The compositions described herein present a novel combination of essential oil active ingredients mint oil and geranium oil, resulting in an improved insecticidal composition that offers the consumers a dual action experience—pleasant low lingering hedonics without sacrificing efficacy and/or time to achieve the desired insecticidal and/or repellent activity. The pleasant fragrance experience allows consumers to spray the pests in a room and remain in the room following application of the composition. In particular, the pest control composition described herein causes pest mortality in small to large bugs by at least weakening pest's exoskeleton and/or obstructing pest's central nervous system, resulting in a pest knockdown rate as much as 88% in 30 seconds, and a pest mortality rate as much as 100% in 24 hours. Applicant also discovered that the novel combination of mint oil and geranium oil unexpectedly masks, and/or neutralizes the unpleasant harsh smell of common inert ingredients (such as ethyl lactate or butyl lactate) present in many insecticidal compositions.

In certain embodiments, the pest control composition includes an active component in addition to other components. In some embodiments, the active component includes one or more essential oils, such as at least one mint oil (e.g., spearmint oil, peppermint oil, and cornmint oil), geranium oil, and/or cinnamon oil. In some embodiments, the active component includes one or more essential oils, such as at least one mint oil (e.g., spearmint oil, peppermint oil, and cornmint oil), geranium oil, and/or cedarwood oil. The compositions of the present disclosure may also include one or more additional components. In certain embodiments, for example, the compositions of the present disclosure may include a carrier, a solvent, a dehydrate, and/or a propellant.

In some embodiments, an active component of the pest control composition of the present disclosure includes one or more essential oils (e.g., spearmint oil, peppermint oil, cornmint oil, geranium oil, cinnamon oil, and/or cedarwood oil). In specific embodiments, the active component of the pest control composition includes at least one mint oil and geranium oil.

The total amount of the active component (e.g., the total amount of essential oils in the composition) may be from about 0.01 wt. %, or from about 0.05 wt. %, or from about 0.5 wt. %, or from about 1 wt. %, or from about 2 wt. %, or from about 2.5 wt. %, or from about 5 wt. %, or from about 6 wt. %, or from about 7 wt. %, or from about 8 wt. %, or from about 9 wt. %, or from about 10 wt. %, and to about 25 wt. %, or to about 22 wt. %, or to about 20 wt. %, or to about 17 wt. %, or to about 15 wt. %, or to about 12 wt. %, or to about 8 wt. %, or to about 6 wt. %, or to about 4 wt. %, or to about 3 wt. %, or to about 2.5 wt. %. In an embodiment, the total amount active component is present in an amount from about 0.05 wt. % to about 15 wt. %, or from about 0.5 wt. % to about 6 wt. %, or from about 1 wt. % to about 4 wt. %, or from about 2 wt. % to about 4 wt. %, wherein all weight percentages are percent by weight of the total composition. In an embodiment, the total amount active component is present in an amount from about 2.5 wt. % to about 3.5 wt. % wherein all weight percentages are percent by weight of the total composition. In an embodiment, the total amount active component is present in an amount of about 3 wt. % based on the total weight of the total composition.

Essential Oils. The pest control composition according to an embodiment of the present disclosure, is a composition that includes essential oils—e.g., at least one mint oil (e.g., spearmint oil, peppermint oil, cornmint oil, and mixtures thereof), geranium oil, cinnamon oil, and/or cedarwood oil. In certain embodiments, the pest control composition includes essential oils of spearmint and geranium oil.

Particular strains of certain essential oils may be especially well-suited for use in certain pest control formulations, for example insecticidal or insect repellent formulations. Additionally, the essential oils help provide a synergistic effect when combined, and in further embodiments, when combined in particular ratios. In particular embodiments, the insecticidal or insect repellent formulations include at least one mint oil (e.g., spearmint oil, peppermint oil, cornmint oil, and mixtures thereof) and geranium oil, cinnamon oil, and/or cedarwood oil.

Spearmint oil. For the purposes of this disclosure, as used herein, “spearmint oil” may refer to both extracted and synthetic versions of Mentha spicata, Mentha crispa, Mentha crispate, Mentha cardiaca G. (scotch spearmint), Mentha spicata L. var. crispa (Bentham) Danert (native spearmint), and/or Mentha viridis, and derivatives thereof. Spearmint is also known as garden mint, common mint, lamb mint, and mackerel mint. Spearmint may also be a species of mint and may be native to Europe and southern temperate Asia, extending from Ireland in the west to southern China in the east. Further, spearmint oil includes a CAS registry number of 8008-79-5. In addition, spearmint oil may have at least one of the following constituents: carvone, d-limonene, (Z)-Dihydrocarvone, menthone, β-myrcene, α-pinene, camphene, sabinene, β-pinene, myrcene, β-octanol, p-cymene, 1,8-cineole, (Z)-β-ocimene, cis-sabinene hydrate, linalool, cis-p-menth-2-en-1-ol, cis-limonene oxide, trans-limonene oxide, borneol, δ-terpineol, 4-terpineol, α-terpineol, dihydrocarveol, cis-dihydrocarvone, trans-carveol, cis-carveol, pulegone, isobornyl acetate, iso-dihydrocarveol acetate, β-bourbonene, β-elemene, β-caryophyllene, germacrene D, germacrene A, spathulenol, caryophyllene oxide, monoterpene hydrocarbons, oxygenated monoterpenes, sesquiterpene hydrocarbons, and/or oxygenated sesquiterpenes. In particular embodiments, the spearmint oil may have at least the following constituents: carvone, limonene, (Z)-Dihydrocarvone, 3-octanol, menthone, 1,8-cineole, and β-myrcene.

Peppermint oil. For the purposes of this disclosure, as used herein, “peppermint oil” may refer to both extracted and synthetic versions of Mentha balsamea Wild, Mentha×piperita L., and derivatives thereof. Peppermint can also be a hybrid mint—a cross between watermint and spearmint. Further, peppermint oil has the CAS registry number 8006-90-4, and may have at least one of the following constituents: menthol, menthone, menthyl acetate, 1,8-cineol, menthofuranne, neomenthol, isomenthone, beta-caryophyllene, germacrene D, limonene, β-pinene, terpinene-4-ol, α-pinene, (6R)-(+)-Menthofuran tr, terpinen-4-ol, (1R)-(+)-3-pulegone, germacrene, β-caryophyllene, (E)-sabinene hydrate, piperitone, and/or isomenthol. In particular embodiments, peppermint oil includes at least the following constituents: menthol, menthone, menthyl acetate, neomenthol, 1,8-cineole, (6R)-(+)-Menthofuran, isomenthone, terpinen-4-ol, (1R)-(+)-β-Pulegone, limonene, germacrene D, β-caryophyllene, (E)-Sabinene hydrate, β-pinene, piperitone, and isomenthol.

Cornmint oil. As used herein, “cornmint oil” may refer to both extracted and synthetic versions of Mentha arvensis, Mentha arvensis L., Mentha arvensis f. piperascens Malinv. Ex Holmes, Mentha arvensis L. var. galbrata Benth, Mentha arvensis L. var. villosa Benth, Mentha canadensis L., and derivatives thereof. Further, cornmint oil has a CAS registry number 68917-18-0. Cornmint is also known as field mint or wild mint. Further, like spearmint oil and peppermint oil, cornmint oil is a species of flowering plant in the mint family Lamiaceae. Cornmint oil may also have at least one of the following constituents: cis-beta-ocimene, β-phellandrene, gamma-terpinene, terpinolene, α-pinene, neomenthol, santene, α-thujene, p-cymene, β-farnesene, β-caryophyllene, betabourbonene, myrcene, β-myrcene, α-terpinene, delta-terpinene, limonene, β-pinene, camphene, sabinene, germacrene D, gamma-caryophyllene, delta-cardinene, ethanol, 3-methylbutanol, 3-octanol, citronellolnerol, menthol, isomenthol, α-terpineol, isopulegol, cis-carveol, pmenthan-2,5-diol, isocaryophyllenol, butanol, (Z)-3-hexenol, 2,6-nonadienol, geraniol, neoisomenthol, terpinen-4-ol, neoiso(iso)pulegol, trans-carveol, borneol, viridiflorol, acetaldehyde, 3-methylbutanal, geranial, 2-methylpropanal, 2,6-nonadienal, neral, acetone, 2-heptanone, 2-isopropylcyclopentanone, 3-methylcyclohexanone, menthone, piperitone, carvone, 2-butanone, methylheptenone, cis-jasmone, carvomenthone, isomenthone, pulegone, (1R)-(+)-β-pulegone, iso-isopulegol, formic acid, 3-methylbutanoic acid, hexanoic acid, nonanoic acid, acetic acid, pentanoic acid, (E)-2-hexenyl acetate, (Z)-3-hexenyl acetate, 1-octen-3-yl acetate, geranyl acetate, linalyl acetate, menthyl acetate, isomenthyl acetate, neomenthyl acetate, neoisomenthyl acetate, dihydrocarvyl acetate, (Z)-3-hexenyl 3-methylbutanoate, menthyl 3-methylbutanoate, menthyl pentanoate, (Z)-3-hexenyl hexanoate, menthyl hexanoate, (Z) hexenyl 2-hydroxybenzoate, (E)-2-hexenyl phenylacetate, (Z)-3-hexenyl phenylacetate, 3-phenylpyridine, 3-phenyl-4-propylpyridine, menthofuran, menthofurolactone, 1,8-cineole, trans-2,5-diethylfuran, 3-(5,5-dimethyltetrahydro-2-furyl)-(Z)-2-butenol-1, piperitone oxide, beta-caryophyllene oxide, and/or 2-isopropyl-5-methylphenol (thymol). In particular embodiments, cornmint oil may include the following major constituents: menthol and menthone.

Geranium oil. As used herein, “geranium oil” refers to both extracted and synthetic oils of geranium, and derivatives thereof. Geranium is a genus of 422 species of annual, biennial, and perennial plants that are commonly known as geraniums or cranesbills. Geranium oil has the CAS registry number 8000-46-2 and at least one of the following constituents: citronellol, geraniol, linalool, citronellyl formiate, menthone, geranyl-formiate, 3,7-gvaiedien, alpha-terpineol, izomenthon, beta-burbonen, tetrahydrogeraniol, alpha-pinene, geranyl-butyrate, linalyl-propionate, cis-rozokside, geranyl-tiglate, beta-caryophyllene, citronellyl-propionate, citronellyl-butyrate, calamenen, neryl-propionate, benzylidene camphor, geranyl-propionate, and/or delta-gvaien. In particular embodiments, geranium oil may include the following major constituents: Citronellol, Citronellyl formate, Geraniol, Guaia-6,9-diene, Isomenthone, Linalool, Menthone, Geranyl formate, (Z)-+(E)-Rose oxide, Germacrene, Geranyl tiglate, Citronellyl propionate, β-Caryophyllene, Citronellyl tiglate, Geranyl butyrate, β-Bourbonene.

In certain embodiments, the pest control composition includes essential oils comprising mint oil selected from the group consisting of spearmint oil, peppermint oil, cornmint oil, and mixtures thereof and geranium oil. In certain embodiments, the pest control composition includes essential oils comprising mint oil selected from the group consisting of spearmint oil, peppermint oil, cornmint oil, and mixtures thereof, and geranium oil.

In certain embodiments, the pest control composition includes (i) mint oil selected from the group consisting of spearmint oil, peppermint oil, cornmint oil, and mixtures thereof, and (ii) geranium oil, wherein the weight ratio of geranium oil to mint oil is from about 0.5:1 to about 20:1. In the present disclosure, Applicant demonstrates that a combination of at least two essential oils unexpectedly provides a pleasant smell, a low linger scent, and a high efficiency of killing/repelling insects. In certain embodiments, the mint oil is spearmint oil. In other embodiments, the mint oil is peppermint oil. In certain embodiments, the mint oil is cornmint oil. In certain embodiments, the mint oil is a mixture of any two or three of spearmint oil, peppermint oil, and cornmint oil. In certain embodiments, the geranium oil and the mint oil have a weight ratio of from about 0.5:1 to about 20:1. In certain embodiments, the geranium oil and the mint oil have a weight ratio of from about 0.6:1 to about 19:1. In certain embodiments, the geranium oil and the mint oil have a weight ratio of from about 0.7:1 to about 19:1. In certain embodiments, the geranium oil and the mint oil have a weight ratio of from about 0.8:1 to about 18:1. In certain embodiments, the geranium oil and the mint oil have a weight ratio of from about 0.9:1 to about 17:1. In certain embodiments, the geranium oil and the mint oil have a weight ratio of from about 1:1 to about 16:1. In accordance with an exemplary embodiment, the geranium oil and the mint oil have a weight ratio of about 1:1 or about 16:1. While specific ratios chosen for this embodiment are recited, it is to be understood that, within the scope of the disclosure, the ratios of the geranium oil and the mint oil may vary to suit different applications.

In certain embodiments, the pest control composition includes (i) mint oil selected from the group consisting of spearmint oil, peppermint oil, cornmint oil, and mixtures thereof, and (ii) geranium oil, wherein the composition includes between about 0.001% to about 5% by weight of mint oil, based on the total weight of the composition, and between about 0.01% to about 5% by weight of geranium oil, based on the total weight of the composition. In certain embodiments, the pest control composition includes between about 0.001% to about 5% by weight of mint oil, based on the total weight of the composition, based on the total weight of the composition. In certain embodiments, the pest control composition includes between about 0.005% to about 4.5% by weight of mint oil, based on the total weight of the composition. In certain embodiments, the pest control composition includes between about 0.008% to about 4% by weight of mint oil, based on the total weight of the composition. In certain embodiments, the pest control composition includes between about 0.01% to about 3.5% by weight of mint oil, based on the total weight of the composition. In certain embodiments, the pest control composition includes between about 0.03% to about 3% by weight of mint oil, based on the total weight of the composition. In certain embodiments, the pest control composition includes between about 0.05% to about 2% by weight of mint oil, based on the total weight of the composition. In certain embodiments, the pest control composition includes between about 0.07% to about 1.5% by weight of mint oil, based on the total weight of the composition. In certain embodiments, the pest control composition includes between about 0.09% to about 1.3% by weight of mint oil, based on the total weight of the composition. In certain embodiments, the pest control composition includes between about 0.1% to about 1% by weight of mint oil, based on the total weight of the composition. In accordance with an exemplary embodiment, the mint oil is present in an amount of about 1.0% by weight of the total composition. While specific values chosen for this embodiment are recited, it is to be understood that, within the scope of the disclosure, the concentrations of the mint oil may vary to suit different applications. The concentration ranges of mint oil will vary based on the additional components of the pest control composition, including, but not limited to, the geranium oil.

In certain embodiments, the pest control composition includes between about 0.01% to about 5% by weight of geranium oil, based on the total weight of the composition. In certain embodiments, the pest control composition includes between about 0.05% to about 4.5% by weight of geranium oil, based on the total weight of the composition. In certain embodiments, the pest control composition includes between about 0.08% to about 4% by weight of geranium oil, based on the total weight of the composition. In certain embodiments, the pest control composition includes between about 0.1% to about 3.5% by weight of geranium oil, based on the total weight of the composition. In certain embodiments, the pest control composition includes between about 0.3% to about 3% by weight of geranium oil, based on the total weight of the composition. In certain embodiments, the pest control composition includes between about 0.4% to about 2.5% by weight of geranium oil, based on the total weight of the composition. In certain embodiments, the pest control composition includes between about 0.5% to about 2% by weight of geranium oil, based on the total weight of the composition. In certain embodiments, the pest control composition includes between about 0.7% to about 1.9% by weight of geranium oil, based on the total weight of the composition. In certain embodiments, the pest control composition includes between about 0.8% to about 1.8% by weight of geranium oil, based on the total weight of the composition. In certain embodiments, the pest control composition includes between about 0.9% to about 1.7% by weight of geranium oil, based on the total weight of the composition. In certain embodiments, the pest control composition includes between about 1% to about 1.6% by weight of geranium oil, based on the total weight of the composition. In accordance with an exemplary embodiment, the geranium oil is present in an amount of about 1% or about 1.6% by weight of the total composition. While specific values chosen for this embodiment are recited, it is to be understood that, within the scope of the disclosure, the concentrations of the geranium oil may vary to suit different applications. The concentration ranges of geranium oil will vary based on the additional components of the pest control composition, including, but not limited to, the mint oil.

In certain embodiments, the pest control composition includes between about 0.001% to about 5% by weight of at least one mint oil, based on the total weight of the composition, based on the total weight of the composition. In certain embodiments, the pest control composition includes between about 0.005% to about 4.5% by weight of mint oil, based on the total weight of the composition. In certain embodiments, the pest control composition includes between about 0.008% to about 4% by weight of mint oil, based on the total weight of the composition. In certain embodiments, the pest control composition includes between about 0.01% to about 3.5% by weight of mint oil, based on the total weight of the composition. In certain embodiments, the pest control composition includes between about 0.03% to about 3% by weight of mint oil, based on the total weight of the composition. In certain embodiments, the pest control composition includes between about 0.05% to about 2% by weight of mint oil, based on the total weight of the composition. In certain embodiments, the pest control composition includes between about 0.07% to about 1.5% by weight of mint oil, based on the total weight of the composition. In certain embodiments, the pest control composition includes between about 0.09% to about 1.3% by weight of mint oil, based on the total weight of the composition. In certain embodiments, the pest control composition includes between about 0.1% to about 1% by weight of mint oil, based on the total weight of the composition. In accordance with an exemplary embodiment, the mint oil is present in an amount of about 1.0% by weight of the total composition. While specific values chosen for this embodiment are recited, it is to be understood that, within the scope of the disclosure, the concentrations of the mint oil may vary to suit different applications. The concentration ranges of mint oil will vary based on the additional components of the pest control composition, including, but not limited to, the geranium oil.

In certain embodiments, the pest control composition includes between about 0.01% to about 5% by weight of geranium oil, based on the total weight of the composition. In certain embodiments, the pest control composition includes between about 0.05% to about 4.5% by weight of geranium oil, based on the total weight of the composition. In certain embodiments, the pest control composition includes between about 0.08% to about 4% by weight of geranium oil, based on the total weight of the composition. In certain embodiments, the pest control composition includes between about 0.1% to about 3.5% by weight of geranium oil, based on the total weight of the composition. In certain embodiments, the pest control composition includes between about 0.3% to about 3% by weight of geranium oil, based on the total weight of the composition. In certain embodiments, the pest control composition includes between about 0.4% to about 2.5% by weight of geranium oil, based on the total weight of the composition. In certain embodiments, the pest control composition includes between about 0.5% to about 2% by weight of geranium oil, based on the total weight of the composition. In certain embodiments, the pest control composition includes between about 0.7% to about 1.9% by weight of geranium oil, based on the total weight of the composition. In certain embodiments, the pest control composition includes between about 0.8% to about 1.8% by weight of geranium oil, based on the total weight of the composition. In certain embodiments, the pest control composition includes between about 0.9% to about 1.7% by weight of geranium oil, based on the total weight of the composition. In certain embodiments, the pest control composition includes between about 1% to about 1.6% by weight of geranium oil, based on the total weight of the composition. In accordance with an exemplary embodiment, the geranium oil is present in an amount of about 1% or about 1.6% by weight of the total composition. While specific values chosen for this embodiment are recited, it is to be understood that, within the scope of the disclosure, the concentrations of the geranium oil may vary to suit different applications. The concentration ranges of geranium oil will vary based on the additional components of the pest control composition, including, but not limited to, the mint oil.

In certain embodiments, the pest control composition includes a third oil. In certain embodiments, the third oil selected from the group consisting of cinnamon oil, cedarwood oil, and mixtures thereof. In an embodiment, the third oil is cinnamon oil. In an embodiment, the third oil is cedarwood oil. In an embodiment, the third oil is a mixture of cinnamon oil and cedarwood oil. In certain embodiments, the pest control composition includes a third oil between about 0.01% to about 5% by weight of the total weight of the composition. In certain embodiments, the pest control composition includes a third oil between about 0.03% to about 4.5% by weight of the total weight of the composition. In certain embodiments, the pest control composition includes a third oil between about 0.05% to about 4% by weight of the total weight of the composition. In certain embodiments, the pest control composition includes a third oil between about 0.07% to about 3.8% by weight of the total weight of the composition. In certain embodiments, the pest control composition includes a third oil between about 0.1% to about 3.5% by weight of the total weight of the composition. In certain embodiments, the pest control composition includes a third oil between about 0.3% to about 3% by weight of the total weight of the composition. In certain embodiments, the pest control composition includes a third oil between about 0.4% to about 2.5% by weight of the total weight of the composition. In certain embodiments, the pest control composition includes a third oil between about 0.5% to about 2% by weight of the total weight of the composition. In certain embodiments, the pest control composition includes a third oil between about 0.6% to about 1.8% by weight of the total weight of the composition. In certain embodiments, the pest control composition includes a third oil between about 0.7% to about 1.5% by weight of the total weight of the composition. In certain embodiments, the pest control composition includes a third oil between about 0.8% to about 1.3% by weight of the total weight of the composition. In accordance with an exemplary embodiment, the third oil is present in an amount of about 1% by weight of the total composition. While specific values chosen for this embodiment are recited, it is to be understood that, within the scope of the disclosure, the concentrations of the third oil may vary to suit different applications. The concentration ranges of the third oil will vary based on the additional components of the pest control composition, including, but not limited to, the mint oil and the geranium oil.

Cinnamon oil. As used herein, “cinnamon oil” refers to both extracted and synthetic oils of species from the genus Cinnamomum in the family Lauraceae, and derivatives thereof. Cinnamon oil has the CAS registry number 8015-91-6 and can have at least one of the following constituents: benzenepropanal, borneol, 3-phenyl-2-propenal, trans-cinnamaldehyde, (+)-cyclosativene, alpha-cubebene, (+)-sativene, 1-caryophyllene, gamma-muurolene, gamma-maaliene, alpha-muurolene, 1,2,4a,5,6,8a-hexahydro-4,7-dimethyl-1-(1-methylethyl)naphthalene, d-cadinene, 1,6-dimethyl-4-(1-methyletyhl)-(1,2,3,4,4a,7)hexahydronaphthalene, 1,1,6-trimethyl-1,2-dihydronaphthalene, t-muurolol, and/or alpha-copaene. In particular embodiments, cinnamon oil may include the following major constituents: Eugenol, Eugenyl acetate, Linalool, (E)-Cinnamyl acetate, Benzyl benzoate, β-Caryophyllene, (E)-Cinnamaldehyde, Safrole, Cinnamyl alcohol.

In certain embodiments, the pest control composition includes between about 0.01% to about 5% by weight of cinnamon oil, based on the total weight of the composition. In certain embodiments, the pest control composition includes between about 0.03% to about 4.5% by weight of cinnamon oil, based on the total weight of the composition. In certain embodiments, the pest control composition includes between about 0.05% to about 4% by weight of cinnamon oil, based on the total weight of the composition. In certain embodiments, the pest control composition includes between about 0.1% to about 3.5% by weight of cinnamon oil, based on the total weight of the composition. In certain embodiments, the pest control composition includes between about 0.3% to about 3% by weight of cinnamon oil, based on the total weight of the composition. In certain embodiments, the pest control composition includes between about 0.4% to about 2.5% by weight of cinnamon oil, based on the total weight of the composition. In certain embodiments, the pest control composition includes between about 0.5% to about 2% by weight of cinnamon oil, based on the total weight of the composition. In certain embodiments, the pest control composition includes between about 0.6% to about 1.8% by weight of cinnamon oil, based on the total weight of the composition. In certain embodiments, the pest control composition includes between about 0.7% to about 1.5% by weight of cinnamon oil, based on the total weight of the composition. In certain embodiments, the pest control composition includes between about 0.8% to about 1.2% by weight of cinnamon oil, based on the total weight of the composition. In accordance with an exemplary embodiment, the cinnamon oil is present in an amount of about 1% by weight of the total composition. While specific values chosen for this embodiment are recited, it is to be understood that, within the scope of the disclosure, the concentrations of the cinnamon oil may vary to suit different applications. The concentration ranges of cinnamon oil will vary based on the additional components of the pest control composition, including, but not limited to, the geranium oil and the mint oil.

An embodiment of the pest control composition disclosed herein includes a pest control composition comprising (i) mint oil selected from the group consisting of spearmint oil, peppermint oil, cornmint oil, and mixtures thereof, (ii) geranium oil, and (iii) cinnamon oil. In certain embodiments, the geranium oil and the mint oil have a weight ratio of from about 0.1:1 to about 2:1. In certain embodiments, the geranium oil and the mint oil have a weight ratio of from about 0.2:1 to about 1.9:1. In certain embodiments, the geranium oil and the mint oil have a weight ratio of from about 0.3:1 to about 1.8:1. In certain embodiments, the geranium oil and the mint oil have a weight ratio of from about 0.4:1 to about 1.6:1. In certain embodiments, the geranium oil and the mint oil have a weight ratio of from about 0.5:1 to about 1.5:1. In certain embodiments, the geranium oil and the mint oil have a weight ratio of from about 0.6:1 to about 1.4:1. In certain embodiments, the geranium oil and the mint oil have a weight ratio of from about 0.7:1 to about 1.3:1. In certain embodiments, the geranium oil and the mint oil have a weight ratio of from about 0.8:1 to about 1.2:1. While specific ratios chosen for this embodiment are recited, it is to be understood that, within the scope of the disclosure, the ratios of the geranium oil and the mint oil may vary to suit different applications.

In certain embodiments, the pest control composition includes between about 0.01% to about 5% by weight of mint oil, based on the total weight of the composition. In certain embodiments, the pest control composition includes between about 0.03% to about 4.5% by weight of mint oil, based on the total weight of the composition. In certain embodiments, the pest control composition includes between about 0.05% to about 4% by weight of mint oil, based on the total weight of the composition. In certain embodiments, the pest control composition includes between about 0.1% to about 3.5% by weight of mint oil, based on the total weight of the composition. In certain embodiments, the pest control composition includes between about 0.3% to about 3% by weight of mint oil, based on the total weight of the composition. In certain embodiments, the pest control composition includes between about 0.4% to about 2.5% by weight of mint oil, based on the total weight of the composition. In certain embodiments, the pest control composition includes between about 0.5% to about 2% by weight of mint oil, based on the total weight of the composition. In certain embodiments, the pest control composition includes between about 0.6% to about 1.8% by weight of mint oil, based on the total weight of the composition. In certain embodiments, the pest control composition includes between about 0.7% to about 1.5% by weight of mint oil, based on the total weight of the composition. In certain embodiments, the pest control composition includes between about 0.8% to about 1.2% by weight of mint oil, based on the total weight of the composition. In accordance with an exemplary embodiment, the mint oil is present in an amount of about 1% by weight of the total composition. While specific values chosen for this embodiment are recited, it is to be understood that, within the scope of the disclosure, the concentrations of the mint oil may vary to suit different applications. The concentration ranges of mint oil will vary based on the additional components of the pest control composition, including, but not limited to, the geranium oil and the cinnamon oil.

In certain embodiments, the pest control composition includes between about 0.01% to about 5% by weight of geranium oil, based on the total weight of the composition. In certain embodiments, the pest control composition includes between about 0.03% to about 4.5% by weight of geranium oil, based on the total weight of the composition. In certain embodiments, the pest control composition includes between about 0.05% to about 4% by weight of geranium oil, based on the total weight of the composition. In certain embodiments, the pest control composition includes between about 0.1% to about 3.5% by weight of geranium oil, based on the total weight of the composition. In certain embodiments, the pest control composition includes between about 0.3% to about 3% by weight of geranium oil, based on the total weight of the composition. In certain embodiments, the pest control composition includes between about 0.4% to about 2.5% by weight of geranium oil, based on the total weight of the composition. In certain embodiments, the pest control composition includes between about 0.5% to about 2% by weight of geranium oil, based on the total weight of the composition. In certain embodiments, the pest control composition includes between about 0.6% to about 1.8% by weight of geranium oil, based on the total weight of the composition. In certain embodiments, the pest control composition includes between about 0.7% to about 1.5% by weight of geranium oil, based on the total weight of the composition. In certain embodiments, the pest control composition includes between about 0.8% to about 1.2% by weight of geranium oil, based on the total weight of the composition. In accordance with an exemplary embodiment, the geranium oil is present in an amount of about 1% by weight of the total composition. While specific values chosen for this embodiment are recited, it is to be understood that, within the scope of the disclosure, the concentrations of the geranium oil may vary to suit different applications. The concentration ranges of geranium oil will vary based on the additional components of the pest control composition, including, but not limited to, the mint oil and the cinnamon oil.

Cedarwood oil. As used herein, “cedarwood oil” refers to both extracted and synthetic oils produced from distilling wood of a number of different junipers and cypresses (of the family Cupressaceae), and derivatives thereof. Cedarwood oil includes the following CAS registry numbers 85085-29-6, 68990-83-0, or 8000-27-9, and may include at least one of the following constituents: α-pinene, α-thujene, Camphene, (β-pinene, Sabinene, Myrcene, α-terpinene, Limonene, β-phellandrene, γ-terpinene, p-cymene, Terpinolene, Isolongifolene, β-cubebene, Linalool, α-longipinene, α-cedrene, α-barbatene, β-cedrene, Terpinen-4-ol, β-funebrene, cis-p-menth-2-en-1-ol, Thujopsene (widdrene), allo-aromadendrene, β-barbatene, trans-piperitol, Selina-4,11-diene, β-chamigrene, α-terpineol, Pseudowiddrene, Bicyclogermacrene, α-cuprenene, Thujopsadiene, δ-cadinene, ar-curcumene, β-cuprenene, Cuparene, Dehydro-β-ionone, 8,9-dehydroneolongifolene, α-cedrol, Widdrol, 3-thujopsanone, α-cadinol, α-cedrenal, α-bisabolol, and/or Thujopsenal, Mayurone. In particular embodiments, cedarwood oil may include the following major constituents: Iso-α-cedrene, Thujopsene, Cedrenol, Cuparene, Longifolene, α-Cedrene, β-Cedrene, Cedrol, Widdrol, α-Chamigrene, β-Chamigrene, α-Selinene, β-Himachalene.

Another embodiment of the pest control composition disclosed herein includes a pest control composition comprising (i) mint oil selected from the group consisting of spearmint oil, peppermint oil, cornmint oil, and mixtures thereof, (ii) geranium oil, and (iii) cedarwood oil. In certain embodiments, the geranium oil and the mint oil have a weight ratio of from about 0.1:1 to about 2:1. In certain embodiments, the geranium oil and the mint oil have a weight ratio of from about 0.2:1 to about 1.9:1. In certain embodiments, the geranium oil and the mint oil have a weight ratio of from about 0.3:1 to about 1.8:1. In certain embodiments, the geranium oil and the mint oil have a weight ratio of from about 0.4:1 to about 1.6:1. In certain embodiments, the geranium oil and the mint oil have a weight ratio of from about 0.5:1 to about 1.5:1. In certain embodiments, the geranium oil and the mint oil have a weight ratio of from about 0.6:1 to about 1.4:1. In certain embodiments, the geranium oil and the mint oil have a weight ratio of from about 0.7:1 to about 1.3:1. In certain embodiments, the geranium oil and the mint oil have a weight ratio of from about 0.8:1 to about 1.2:1. While specific ratios chosen for this embodiment are recited, it is to be understood that, within the scope of the disclosure, the ratios of the geranium oil and the mint oil may vary to suit different applications.

In certain embodiments, the pest control composition includes between about 0.01% to about 5% by weight of cedarwood oil, based on the total weight of the composition. In certain embodiments, the pest control composition includes between about 0.03% to about 4.5% by weight of cedarwood oil, based on the total weight of the composition. In certain embodiments, the pest control composition includes between about 0.05% to about 4% by weight of cedarwood oil, based on the total weight of the composition. In certain embodiments, the pest control composition includes between about 0.1% to about 3.5% by weight of cedarwood oil, based on the total weight of the composition. In certain embodiments, the pest control composition includes between about 0.3% to about 3% by weight of cedarwood oil, based on the total weight of the composition. In certain embodiments, the pest control composition includes between about 0.4% to about 2.5% by weight of cedarwood oil, based on the total weight of the composition. In certain embodiments, the pest control composition includes between about 0.5% to about 2% by weight of cedarwood oil, based on the total weight of the composition. In certain embodiments, the pest control composition includes between about 0.6% to about 1.8% by weight of cedarwood oil, based on the total weight of the composition. In certain embodiments, the pest control composition includes between about 0.7% to about 1.5% by weight of cedarwood oil, based on the total weight of the composition. In certain embodiments, the pest control composition includes between about 0.8% to about 1.2% by weight of cedarwood oil, based on the total weight of the composition. In accordance with an exemplary embodiment, the cedarwood oil is present in an amount of about 1% by weight of the total composition. While specific values chosen for this embodiment are recited, it is to be understood that, within the scope of the disclosure, the concentrations of the cedarwood oil may vary to suit different applications. The concentration ranges of cedarwood oil will vary based on the additional components of the pest control composition, including, but not limited to, the geranium oil and the mint oil.

Rosemary oil. As used herein, “rosemary oil” refers to both extracted and synthetic versions of oils from Rosmarinus officinalis, Limonium vulgare, Andromeda polifolia, and derivatives thereof. Further, rosemary oil includes a CAS registry number of 8000-25-7, and may include at least one of the following constituents: tricyclene, alpha-thujene, alpha-pinene, camphene, sabinene, beta-pinene, myrcene, alpha-phellandrene, car-3-ene, alpha-terpinolene, p-cymene, 1,8-cineole, limonene, gamma-terpinene, trans-sabinene, terpinolene, linalool, alpha-campholenol, endo-fenchol, and/or camphor. In particular embodiments, rosemary oil may include the following major constituents: 1,8-cineole, borneol, camphor, verbenone, α-pinene, bornyl acetate, linalool, camphene, β-caryophyllene, α-terpineol, p-cymene, ar-curcumene, 1-nonanol, and terpinen-4-ol.

Another embodiment of the pest control composition disclosed herein includes a pest control composition comprising mint oil selected from the group consisting of spearmint oil, peppermint oil, cornmint oil, and mixtures thereof, at least one of rosemary oil, geranium oil, cinnamon oil, cedarwood oil, and mixtures thereof, and at least one of ethyl lactate, butyl lactate, and mixtures thereof.

Other plant-based pest control natural oil or natural oil extract that may be contained in the embodiments of compositions for killing insects and/or repelling insects described herein may comprise neem oil, karanja oil, clove oil, thyme oil, oregano oil, garlic oil, anise oil, lime oil, lavender oil, thymol (found in oregano oil and thyme oil), p-cymene (found in oregano oil and thyme oil), 1,8-cineole (found in thyme oil and peppermint oil), eugenol (found in clove oil and cinnamon oil), limonene (found in cinnamon, peppermint, and lime oil), alpha-pinene (found in cinnamon oil, geranium oil, and lime oil), carvacrol (found in oregano oil, thyme oil, and clove oil), gamma-terpinene (found in oregano oil and lime oil), geraniol (found in thyme oil and geranium oil), alpha-Terpineol (found in thyme oil and anise oil), beta-caryophyllene (found in clove oil, cinnamon oil, and peppermint oil) and linalool (found in thyme oil, cinnamon oil and geranium oil, amongst others), or mixtures thereof. In other embodiments, the pest control natural oil may comprise any oil having as a constituent one of the following compounds, or a combination of the following compounds: azadirachtin, nimbin, nimbinin, salannin, gedunin, geraniol, geranial, gamma-terpinene, alpha-terpin-eol, beta-caryophyllene, terpinen-4-ol, myrcenol-8, thuya-nol-4, benzyl alcohol, cinnamaldehyde, cinnamyl acetate, alpha-pinene, geranyl acetate, citronellol, citronellyl formate, isomenthone, 10-epi-gamma-eudesmol, 1,5-dimethyl-1-vinyl-4-hexenylbutyrate, 1,3,7-octatriene, eucalyptol, camphor, diallyl disulfide, methyl allyl trisulfide, 3-vinyl-4H-1,2 dithiin, 3-vinyl-1,2 dithiole-5-cyclohexane, diallyl trisulfide, anethole, methyl chavicol, anisaldehyde, estragole, linalyl acetate, geranial, beta-pinene, thymol, carvacrol, p-cymene, beta-myrcene, alpha-myrcene, 1,8-cin-eole, eugenol, limonene, alpha-pinene, menthol, menthone, linalool, or mixtures thereof.

In further embodiments, other plant-based essential oil or extracts or fractions thereof that may be contained in the embodiments of compositions for killing insects and/or repelling insects described herein may comprise alpha- or beta-pinene; alpha-camp-holenic aldehyde; alpha-citronellol; alpha-iso-amyl-cinnamic (e.g., amyl cinnamic aldehyde); alpha-pinene oxide; alpha-cinnamic terpinene; alpha-terpineol (e.g., 1-methyl-4-isopropyl-1-cyclohexen-8-ol); lamda-terpinene; achillea; aldehyde C16 (pure); allicin; alpha-phellandrene; amyl cinnamic aldehyde;

amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; borneol; calamus; camphor; cananga oil (e.g., java); cardamom; carnation (e.g., dianthus caryophyllus); carvacrol; carveol; cassia; castor; cedar (e.g., hinoki); chamomile; cineole; cinnamaldehyde; cinnamic alcohol; cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; d-dihydrocarvone; decyl aldehyde; diallyl disulfide; diethyl phthalate; dihydroanethole; dihydrocarveol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Femiol™; fish; florazon (e.g., 4-ethyl-.alpha., .alpha.-dimethyl-benzenepropanal); galaxolide; geraniol (e.g., 2-trans-3,7-dimethyl-2,6-octadien-8-ol); geraniol; geranyl acetate; geranyl nitrile; ginger; grapefruit; guaiacol; guaiacwood; gurjun balsam; heliotropin; herbanate (e.g., 3-(1-methyl-ethyl) bicyclo(2,2,1) hept-5-ene-2-carboxylic acid ethyl ester); hiba; hydroxycitronellal; i-carvone; i-methylacetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalyl acetate; linseed; litsea cubeba; I-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methylcyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., myristica fragrans); orange (e.g., Citrus aurantium dulcis); orris (e.g., Iris florentina) root; para-cymene; para-hydroxy phenyl butanone crystals (e.g., 4-(4-hydroxphenyl)-2-butanone); passion palmarosa oil (e.g., Cymbopogon martini), patchouli (e.g., Pogostemon cablin), p-cymene; pennyroyal oil; pepper; peppermint (e.g., Mentha piperita), perillaldehyde; petitgrain (e.g., Citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., Rosmarinus officinalis), ryu; sage; sandalwood (e.g., Santa-lum album), sandenol; sassafras; sesame; soybean; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; wintergreen (methyl salicylate) oils, or mixtures thereof.

Other suitable essential oils for use in the pest control compositions described herein include Absinth Oil, Almond Oil, Ambrette Seed Oil, Amyris Oil, Angelica Root Oil, Anethole 20/21 natural, Angelica Seed Oil, Aniseed Oil China star, Anise Star Oil, Balsam Fir Oil, Balsam Oil, Basil Oil, Bay Oil, Bergamot Oil, Birch Sweet Oil, Birch Tar Oil, Bitter Almond Oil, Bitter Orange Oil Cold Pressed, Black Pepper Oil Black Pepper Oleoresin 40/20, Bois de Rose, Buchu Oil, Cabreuva Oil, Cade Oil, Cajeput Oil, Calamus Oil, Camphor Oil White, Cananga Oil, Capsicum Oil, Caraway Seed Oil, Cardamom Seed Oil, Carrot Seed Oil, Cassia Oil, Cedar leaf Oil, Cedarwood Oil, Celery Leaf Oil, Celery Seed Oil, Chamomile Flower Oil, Chenopodium Oil (Wormseed), Cinnamon Bark Oil, Cinnamon Leaf Oil, Cistus Oil, Citronella Oil, Citronellol Terpenes, Clary Sage Oil, Clove Bud Oil, Clove Leaf Oil, Clove Stem Oil, Cognac Oil Green, Cognac Oil White, Copaiba Oil, Coriander Leaf Oil, Coriander Seed Oil, Cornmint Oil (Mentha Arvensis), Cumin Seed Oil, Cyclamen Oil, Cypress Oil, Davana Oil, Dill Herb Oil, Erigeron Oil, Estragon Oil (Tarragon Oil), Eucalyptus Oil, Fennel Oil Bitter, Fennel Oil Sweet, Fir Needle Oil, Galbanum Oil, Garlic Oil, Geranium Oil, Ginger Oil, Grapefruit Oil 10-Fold, Grapefruit Oil 5-Fold, Grapefruit Oil Cold Pressed, Grapefruit Oil Terpenes, Guaiac Wood Oil, Gurjun Balsam, Hemlock Oil (Spruce), Ho Leaf Oil, Ho Wood Oil, Hyssop Oil, Jasmin Oil, Juniper Berry Oil, Laurel Leaf Oil, Lavandin Oil, Lavender Oil, Lavender Spike Oil, Lemon Oil 10-Fold, Lemon Oil 5-Fold, Lemon Oil Cold Pressed, Lemon Oil Distilled, Lemon Oil Terpenes, Lemon Oil Washed, Lemongrass Oil, Lemongrass Oil Terpeneless, Lime Oil 5-Fold, Lime Oil Distilled, Lime Oil Terpenes, Lime Oil Washed, Litsea Cubeba Berry Oil, Mace Oil, Mandarin Oil Cold Pressed, Marjoram Oil Sweet, Musk Oil, Myrtel Oil, Neroli Oil, Nutmeg Oil, Ocotea Cymbarum Oil, Onion Oil, Orange Oil Bitter Cold Pressed, Orange Oil 10-Fold, Orange Oil20-Fold, Orange Oil 5-Fold, Orange Oil Bitter 5-Fold, Orange Oil Cold Pressed, Orange Oil Terpeneless, Oregano Oil, Origanum Oil, Palmarosa Oil, Parsley Leaf Oil, Parsley Seed Oil, Patchouli Oil, Pennroyal Oil, Pepper Oil Black, Peppermint Oil, Petitgrain Oil, Pimenta Berry Oil, Pimenta Leaf Oil, Pine Needle Oil, Pine Oil Scotch, Pine Oil White, Rosalin Oil, Rose Oil, Sage Clary Oil, Sage Oil, Sandalwood Oil, Sassafras Oil, Savory Oil, Spike Lavender Oil (Lavender Spike), Spruce Oil(Hemlock), Star Anise Oil, Styrax Oil, Tagetes Oil, Tangelo Oil, Tangerine Oil, Tangerine Oil 5-Fold, Tangerine Oil Terpenes, Tarragon Oil (Estragon Oil), Tea Tree Oil, Thyme Oil, Thyme Oil White, Tumeric Oil, Purpentine Oil, Valerian Oil, Vanilla beans abs., Vetiver Oil, Wintergreen Oil (Methyl Salicylate Natural), Wormseed Oil, Wormwood Oil, and Ylang Ylang Oil.

In certain circumstances, the composition may include one or more ingredients eligible for minimum risk pesticide products that are exempt from the Federal Insecticide, Fungicide, and Rodenticide Act (FIFRA) under the Minimum Risk Exemption regulations in 40 U.S. Code of Federal Regulations 152.25(f), for example, included, but not limited to, those listed as “Active Ingredients Permitted in Exempted Minimum Risk Pesticide Products” in 40 U.S. Code of Federal Regulations 152.25(f).

The compositions of the present disclosure, and the active component thereof, may also include other ingredients other than essential oils. In certain embodiments, for example, the compositions of the present disclosure may include a carrier, a solvent, a dehydrate, and/or a propellant.

Carrier. In certain embodiments, the composition includes a carrier. The term “carrier” as used herein means a material, which can be inorganic or organic and of synthetic or natural origin, with which the active compound is mixed or formulated to facilitate its application to the host, area, or other object to be treated, or to facilitate its storage, transport and/or handling. In general, any of the materials customarily employed in formulating repellents, pesticides, herbicides, or fungicides, are suitable.

The pest control composition according to an embodiment of the present disclosure is a composition including at least one mint oil (e.g., spearmint oil, peppermint oil, cornmint oil, and mixtures thereof), at least one of geranium oil, cinnamon oil, cedarwood oil, and mixtures thereof, and a carrier.

In certain embodiments, the carrier includes a hydrocarbon solvent. In certain embodiments, the hydrocarbon solvent is selected from the group consisting of aliphatic C₉-C₁₄ hydrocarbons, alicyclic C₉-C₁₄ hydrocarbons, naphtha, petroleum distillate, paraffins, iso-paraffins, isoparaffinic hydrocarbons, cycloparaffins, alkanes, iso-alkanes, cycloalkanes, mineral oil, white mineral oil, and any combinations thereof. In certain embodiments, the hydrocarbon solvent is mineral oil. In certain embodiments, the hydrocarbon solvent is white mineral oil.

In certain embodiments, the composition includes about 60% to about 90% by weight carrier, based on the total weight of the composition. In certain embodiments, the composition includes about 63% to about 87% by weight carrier, based on the total weight of the composition. In certain embodiments, the composition includes about 65% to about 85% by weight carrier, based on the total weight of the composition. In certain embodiments, the composition includes about 70% to about 83% by weight carrier, based on the total weight of the composition. In certain embodiments, the composition includes about 75% to about 80% by weight carrier, based on the total weight of the composition. While specific values chosen for this embodiment are recited, it is to be understood that, within the scope of the disclosure, the amount of carrier may vary to suit different applications. The amount ranges of carrier will vary based on the additional components of the pest control composition, including, but not limited to, the mint oil and the geranium oil.

Solvent. The formulation or composition of the present disclosure may also include a solvent, for example to dissolve certain components, to enhance functionality of the components, or for textural and sensorial attributes. In certain embodiments, the solvent includes at least one of ethyl lactate, butyl lactate, isopropyl alcohol, and any combinations thereof. In certain embodiments, the solvent includes at least one of ethyl lactate, butyl lactate, and any combinations thereof. In certain embodiments, the composition includes about 1% to about 10% by weight of the solvent, based on the total weight of the composition. In certain embodiments, the composition includes about 2% to about 9% by weight of the solvent, based on the total weight of the composition. In certain embodiments, the composition includes about 3% to about 8% by weight of the solvent, based on the total weight of the composition. In certain embodiments, the composition includes about 4% to about 7% by weight of the solvent, based on the total weight of the composition. While specific values chosen for this embodiment are recited, it is to be understood that, within the scope of the disclosure, the concentration of solvent may vary to suit different applications. The concentration ranges of solvent will vary based on the additional components of the pest control composition, including, but not limited to, the mint oil and the geranium oil.

Dehydrate. In certain embodiments, the composition includes a dehydrate. The term “dehydrate” as used herein means a desiccant or dehydrating material, which can be inorganic or organic and of synthetic or natural origin, with which the active compound is mixed or formulated to facilitate its application to the host, area, or other object to be treated, or to facilitate insecticidal activity by dehydration of the insects. In general, any of the materials customarily employed in formulating repellents, pesticides, herbicides, or fungicides, are suitable. In certain embodiments, the dehydrate is isopropyl myristate. In certain embodiments, the composition includes about 1% to about 15% by weight isopropyl myristate, based on the total weight of the composition. In certain embodiments, the composition includes about 3% to about 14% by weight isopropyl myristate, based on the total weight of the composition. In certain embodiments, the composition includes about 5% to about 13% by weight isopropyl myristate, based on the total weight of the composition. In certain embodiments, the composition includes about 8% to about 12% by weight isopropyl myristate, based on the total weight of the composition. While specific values chosen for this embodiment are recited, it is to be understood that, within the scope of the disclosure, the concentration of isopropyl myristate may vary to suit different applications. The concentration ranges of isopropyl myristate will vary based on the additional components of the pest control composition, including, but not limited to, the mint oil and the geranium oil.

Propellant. In certain embodiments, the composition includes a propellant, for example to provide a force to expel the formulation from the container. Here, the insecticidally-active compositions of the present disclosure may be combined with a suitable propellant to form an aerosol formulation. In certain embodiments, the composition also includes a propellant. However, in other embodiments, the composition does not include a propellant and may be dispensed from a container manually, such as from a trigger-actuated container. In certain embodiments, the propellant is selected from the group consisting of methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. Examples of suitable propellants include compressed gas propellants such as nitrogen, carbon dioxide, and nitrous oxide; liquefied gas propellants such as fluorinated and chlorinated hydrocarbons, dimethyl ether, vinyl chloride; saturated hydrocarbons or lower (C₁-C₄) aliphatic hydrocarbons, such as propane, butane, isobutane, isopentane, and mixtures thereof; and mixtures of liquefied gases and compressed gases. In order to reduce environmental pollution, it may be preferred to employ compressed gasses as the propellant rather than, or in the place of, liquefied saturated hydrocarbons.

In certain embodiments, the composition includes about 1% to about 5% by weight the propellant, based on the total weight of the composition. In certain embodiments, the composition includes about 1.5% to about 4.5% by weight the propellant, based on the total weight of the composition. In certain embodiments, the composition includes about 2% to about 4% by weight the propellant, based on the total weight of the composition. In certain embodiments, the composition includes about 2.5% to about 3.5% by weight the propellant, based on the total weight of the composition. In certain embodiments, the composition includes about 2.7% to about 3% by weight the propellant, based on the total weight of the composition. While specific values chosen for this embodiment are recited, it is to be understood that, within the scope of the disclosure, the concentration of propellant may vary to suit different applications. The concentration ranges of propellant will vary based on the additional components of the pest control composition, including, but not limited to, the mint oil and the geranium oil. In other embodiments, the hydrocarbon propellant may be present in the compositions of this disclosure in an amount of from about 8% to about 50%, from about 15% to about 50%, from about 15% to about 40%, from about 15% to about 25%, or from about 5% to about 30% by weight, based on the total weight of the composition.

In certain embodiments, the pest control composition includes between about 0.01% to about 5% by weight of mint oil, based on the total weight of the composition. In certain embodiments, the pest control composition includes between about 0.03% to about 4.5% by weight of mint oil, based on the total weight of the composition. In certain embodiments, the pest control composition includes between about 0.05% to about 4% by weight of mint oil, based on the total weight of the composition. In certain embodiments, the pest control composition includes between about 0.1% to about 3.5% by weight of mint oil, based on the total weight of the composition. In certain embodiments, the pest control composition includes between about 0.3% to about 3% by weight of mint oil, based on the total weight of the composition. In certain embodiments, the pest control composition includes between about 0.4% to about 2.5% by weight of mint oil, based on the total weight of the composition. In certain embodiments, the pest control composition includes between about 0.5% to about 2% by weight of mint oil, based on the total weight of the composition. In certain embodiments, the pest control composition includes between about 0.6% to about 1.8% by weight of mint oil, based on the total weight of the composition. In certain embodiments, the pest control composition includes between about 0.7% to about 1.5% by weight of mint oil, based on the total weight of the composition. In certain embodiments, the pest control composition includes between about 0.8% to about 1.2% by weight of mint oil, based on the total weight of the composition. In accordance with an exemplary embodiment, the mint oil is present in an amount of about 1% by weight of the total composition. While specific values chosen for this embodiment are recited, it is to be understood that, within the scope of the disclosure, the concentrations of the mint oil may vary to suit different applications. The concentration ranges of mint oil will vary based on the additional components of the pest control composition, including, but not limited to, the geranium oil and the cedarwood oil.

In certain embodiments, the pest control composition includes between about 0.01% to about 5% by weight of geranium oil, based on the total weight of the composition. In certain embodiments, the pest control composition includes between about 0.03% to about 4.5% by weight of geranium oil, based on the total weight of the composition. In certain embodiments, the pest control composition includes between about 0.05% to about 4% by weight of geranium oil, based on the total weight of the composition. In certain embodiments, the pest control composition includes between about 0.1% to about 3.5% by weight of geranium oil, based on the total weight of the composition. In certain embodiments, the pest control composition includes between about 0.3% to about 3% by weight of geranium oil, based on the total weight of the composition. In certain embodiments, the pest control composition includes between about 0.4% to about 2.5% by weight of geranium oil, based on the total weight of the composition. In certain embodiments, the pest control composition includes between about 0.5% to about 2% by weight of geranium oil, based on the total weight of the composition. In certain embodiments, the pest control composition includes between about 0.6% to about 1.8% by weight of geranium oil, based on the total weight of the composition. In certain embodiments, the pest control composition includes between about 0.7% to about 1.5% by weight of geranium oil, based on the total weight of the composition. In certain embodiments, the pest control composition includes between about 0.8% to about 1.2% by weight of geranium oil, based on the total weight of the composition. In accordance with an exemplary embodiment, the geranium oil is present in an amount of about 1% by weight of the total composition. While specific values chosen for this embodiment are recited, it is to be understood that, within the scope of the disclosure, the concentrations of the geranium oil may vary to suit different applications. The concentration ranges of geranium oil will vary based on the additional components of the pest control composition, including, but not limited to, the mint oil and the cedarwood oil.

In certain embodiments, the pest control composition is substantially free of water. In certain embodiments, the pest control composition is free of water.

In certain embodiments, the solvent is selected from the group consisting of ethyl lactate, butyl lactate, isopropyl alcohol, and any combinations thereof.

In certain embodiments, the carrier consists essentially of a hydrocarbon solvent. In certain embodiments, the solvent consists of a hydrocarbon solvent.

In certain embodiments, the pest control composition provides a pest mortality rate of at least 96%, at least 97%, at least 98%, at least 99%, or at least 100% in 24 hours in at least the American cockroach, German cockroach, Argentine ant, and Pharaoh ant. In certain embodiments, the pest control composition provides a pest knockdown rate of at least 88%, at least 92%, at least 94%, at least 96%, at least 98%, at least 99%, or at least 100% in 30 seconds in at least the German cockroach, Argentine ant, and Pharaoh ant.

Another embodiment of the pest control composition disclosed herein includes a pest control composition comprising mint oil selected from the group consisting of spearmint oil, peppermint oil, cornmint oil, and mixtures thereof, at least one of rosemary oil, geranium oil, cinnamon oil, cedarwood oil, and mixtures thereof, at least one of ethyl lactate, butyl lactate, isopropyl alcohol, and mixtures thereof, and isopropyl myristate.

Another embodiment of the pest control composition disclosed herein includes a method of killing insects comprising applying to a surface in need thereof a composition comprising at least one of spearmint oil, peppermint oil, cornmint oil, and mixtures thereof, at least one oil comprising rosemary oil, geranium oil, cinnamon oil, cedarwood oil, and mixtures thereof, and at least one of ethyl lactate, butyl lactate, and mixtures thereof.

Another embodiment of the pest control composition disclosed herein includes a method of killing insects comprising applying to a surface in need thereof a composition comprising at least one of spearmint oil, peppermint oil, cornmint oil, and mixtures thereof, at least one oil comprising rosemary oil, geranium oil, cinnamon oil, cedarwood oil, and mixtures thereof, at least one of ethyl lactate, butyl lactate, isopropyl alcohol, and mixtures thereof, and isopropyl myristate.

Any of the embodiments described herein may be modified to include any of the structures, compositions, or methodologies disclosed in connection with different embodiments.

### EXAMPLES

The following Examples are provided to demonstrate and further illustrate certain embodiments and aspects of the present disclosure and are not to be construed as limiting the scope of the disclosure.

In certain embodiments, as will be illustrated through the Examples, the pest control composition provides a pest mortality rate of about 100% in 24 hours, and in some embodiments, the pest control composition provides a pest knockdown rate of about 90% in 30 seconds.

Unless stated otherwise, the efficacy tests were conducted in accordance with the U.S. Environmental Protection Agency Product Performance Test Guidelines, OCSPP 810.3500: Premises Treatments, which provides recommendations for the design and execution of laboratory and field studies to evaluate the performance of pesticide products applied in or around premises in connection with registration of pesticide products under the Federal Insecticide, Fungicide, and Rodenticide Act (FIFRA) (7 U.S.C. 136, et seq.). The entire contents of these testing guidelines are incorporated by reference herein.

In general, the following data was recorded for each sample set: sample group size, genus species, sex, maturity and general condition. The number of insects knocked down after thirty seconds and number of insects dead after twenty-four hours post treatment were also recorded. The conditions of the testing area (temperature, humidity, date and time) were also clearly associated with each testing round of samples and control. Additionally, the knockdown and mortality results were reported in both number relative to sample size and as a percentage of the sample size.

For crawling insects, the formulations were tested by treating the insects (e.g., cockroaches, Blattella germanica, Periplaneta americana, ants, Linepithema humile, Monomorium pharaonis) on a large platform with clean craft paper placed on its surface. A large “arena” ring was placed on top of the paper, with a smaller treatment ring in the center, placed on top of a sheet of vinyl flooring. Twenty seconds after treatment the smaller treatment ring was removed. Knockdown observations were taken either thirty seconds or two minutes after application of formulation to the insects. Approximately two minutes post treatment, insects were collected from the arena and placed into clean holding containers for twenty-four-hour mortality observations. A group of untreated insects were also held in clean containers for twenty-four-hour mortality observations as a control to the treated test system.

### Example 1

Several formulations according to embodiments of the present disclosure were tested and efficacy data, including knockdown and mortality data, was collected for the formulations.

The following ingredients in Table 1 are used to prepare formulations A-D.

Formulations A-D are oil-based insecticidal formulations and comprise about 1.0% or 0.1% spearmint or peppermint or cornmint oil; about 1.0% or about 1.6% geranium oil; about 1.0% cinnamon leaf oil; about 1.0% cedarwood oil; about 76% to about 80% carrier; about 10.7% to about 10.8% isopropyl myristate; about 6.7% solvent; and about 2.9% of an optional propellant.

TABLE 1
Components of formulations A-D.

| | Formu- | Formu- | Formu- | Formu- |
|---|---|---|---|---|
| | lation | lation | lation | lation |
| Ingredient | A (wt %) | B (wt %) | C (wt %) | D (wt %) |
| Spearmint or | 1.00% | 1.00% | 0.10% | 0.10% |
| peppermint or | | | | |
| cornmint oil | | | | |
| Geranium oil | 1.00% | 1.00% | 1.60% | 1.60% |
| Cinnamon leaf oil | 1.00% | 1.00% | 0.00% | 0.00% |
| Cedarwood oil | 0.00% | 0.00% | 1.00% | 1.00% |
| White mineral oil | 76.72% | 79.57% | 77.02% | 79.87% |
| Isopropyl | 10.73% | 10.73% | 10.73% | 10.73% |
| myristate | | | | |
| Ethyl lactate or | 6.70% | 6.70% | 6.70% | 6.70% |
| butyl lactate or | | | | |
| isopropyl alcohol | | | | |
| Carbon dioxide | 2.85% | 0.00% | 2.85% | 0.00% |
| (CO₂) | | | | |

Formulations A-D were tested according to the premises treatment procedures discussed above. The results are summarized in Table 2 below. Formulations A-D showed exceptional performance with 90% or greater efficacy in all species tests for mortality (24 hours). Formulations A-D showed excellent performance with 88% or greater efficacy against German cockroaches and house flies for knockdown (30 sec).

TABLE 2
Efficacy data of formulations A-D.

| | Formu- | Formu- | Formu- | Formu- |
|---|---|---|---|---|
| Efficacy | lation A | lation B | lation C | lation D |
| American | 20% | 20% | 20% | 20% |
| cockroach | | | | |
| (Periplaneta | | | | |
| americana) | | | | |
| mean % | | | | |
| knockdown 30 | | | | |
| seconds | | | | |
| American | 100% | 100% | 100% | 100% |
| cockroach | | | | |
| (Periplaneta | | | | |
| americana) | | | | |
| mean % | | | | |
| mortality 24 | | | | |
| hours | | | | |
| German | 100% | 88% | 100% | 92% |
| cockroach | | | | |
| (Blattella | | | | |
| germanica) | | | | |
| mean % | | | | |
| knockdown 30 | | | | |
| seconds | | | | |
| German | 100% | 100% | 100% | 100% |
| cockroach | | | | |
| (Blattella | | | | |
| germanica) | | | | |
| mean % | | | | |
| mortality 24 | | | | |
| hours | | | | |

### Example 2

In addition to studying the efficacy of several formulations of the present disclosure, the effect of changing the relative amounts of the essential oils, specifically geranium oil, spearmint oil, and cinnamon oil, was studied. Here, Formulations 1-12 were prepared according to the weight percentages shown in Tables 3, 4, 5, and 6. The total amount of essential oils was kept constant at 5%, and the other ingredients included in the formulations were kept constant at 10% butyl lactate, 10% isopropyl myristate, and 75% mineral oil.

As shown in Table 3, Formulation 1 included 100% geranium oil and did not include any spearmint oil or cinnamon oil, while Formulation 2 included 100% spearmint oil and did not include geranium oil or cinnamon oil. Further, Formulations 3-8 tested ratios between the geranium oil and the mint oil (i.e., spearmint oil, in this embodiment) of 20:1 (Formulation 3), 10:1 (Formulation 4), 2:1 (Formulation 5), 1:1 (Formulation 6), 1:10 (Formulation 7), and 1:100 (Formulation 8). Formulations 9-12 tested ratios between the geranium oil, mint oil, and cinnamon oil of 1:1:1 (Formulation 9), 0:1:1 (Formulation 10), 1:0:1 (Formulation 11), and 0:0:1 (Formulation 12).

TABLE 3
Components of Formulations 1-3.

| | Formu- | Formu- | Formu- |
|---|---|---|---|
| | lation | lation | lation |
| | 1 | 2 | 3 |
| Ingredient | (wt. %) | (wt. %) | (wt. %) |
| Geranium Oil | 5.00% | 0.00% | 4.762% |
| Spearmint Oil | 0.00% | 5.00% | 0.238% |
| Cinnamon Oil | 0.00% | 0.00% | 0.00% |
| Butyl Lactate | 10.00% | 10.00% | 10.00% |
| Isopropyl Myristate | 10.00% | 10.00% | 10.00% |
| Mineral Oil | 75.00% | 75.00% | 75.00% |

TABLE 4
Components of Formulations 4-6.

| | Formu- | Formu- | Formu- |
|---|---|---|---|
| | lation | lation | lation |
| | 4 | 5 | 6 |
| Ingredient | (wt. %) | (wt. %) | (wt. %) |
| Geranium Oil | 4.545% | 3.333% | 2.50% |
| Spearmint Oil | 0.455% | 1.667% | 2.50% |
| Cinnamon Oil | 0.00% | 0.00% | 0.00% |
| Butyl Lactate | 10.00% | 10.00% | 10.00% |
| Isopropyl Myristate | 10.00% | 10.00% | 10.00% |
| Mineral Oil | 75.00% | 75.00% | 75.00% |

TABLE 5
Components of Formulations 7-9.

| | Formu- | Formu- | Formu- |
|---|---|---|---|
| | lation | lation | lation |
| | 7 | 8 | 9 |
| Ingredient | (wt. %) | (wt. %) | (wt. %) |
| Geranium Oil | 0.455% | 0.05% | 1.667% |
| Spearmint Oil | 4.545% | 4.95% | 1.667% |
| Cinnamon Oil | 0.00% | 0.00% | 1.667% |
| Butyl Lactate | 10.00% | 10.00% | 10.00% |
| Isopropyl Myristate | 10.00% | 10.00% | 10.00% |
| Mineral Oil | 75.00% | 75.00% | 75.00% |

TABLE 6
Components of Formulations 10-12.

| | Formu- | Formu- | Formu- |
|---|---|---|---|
| | lation | lation | lation |
| | 10 | 11 | 12 |
| Ingredient | (wt. %) | (wt. %) | (wt. %) |
| Geranium Oil | 0.00% | 2.50% | 0.00% |
| Spearmint Oil | 2.50% | 0.00% | 0.00% |
| Cinnamon Oil | 2.50% | 2.50% | 5.00% |
| Butyl Lactate | 10.00% | 10.00% | 10.00% |
| Isopropyl Myristate | 10.00% | 10.00% | 10.00% |
| Mineral Oil | 75.00% | 75.00% | 75.00% |

The efficacy data, including the knockdown percentage (after 30 seconds) and mortality percentage (after 24 hours), was observed for one crawling insect (Blattella germanica). The results from the efficacy tests are provided in Table 7 below.

As shown in the efficacy data in Table 7, each ratio of mint oil (i.e., spearmint oil, in this embodiment) to geranium oil exhibited strong knockdown and strong mortality results. Additionally, each ratio of mint oil to geranium oil, to a third oil (i.e., cinnamon oil, in this example) also exhibited strong knockdown and strong mortality results. The formulations with lower efficacy data were typically ones lacking at least one mint oil or at least one geranium oil, thereby showcasing the synergistic effect added to a formulation by way of the combination of at least one mint oil and a geranium oil. Overall, the treated test systems exhibited 24-hour mean mortality of about 100%, and 30-second knockdown of greater than 83%, and in particular greater than 90%, thereby exhibiting the efficacy of formulations of the present disclosure and the wide range of ratios the mint oil and the rosemary oil may be in relative to one another while still providing optimal insecticidal properties.

TABLE 7
Efficacy Data for Formulations 1-12.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 1 | 100.00% | 100.00% |
| 2 | 98.34% | 100.00% |
| 3 | 100.00% | 100.00% |
| 4 | 100.00% | 100.00% |
| 5 | 100.00% | 100.00% |
| 6 | 100.00% | 100.00% |
| 7 | 100.00% | 100.00% |
| 8 | 100.00% | 100.00% |
| 9 | 83.33% | 100.00% |
| 10 | 63.33% | 100.00% |
| 11 | 50.00% | 100.00% |
| 12 | 83.34% | 100.00% |

### Example 3

The effect of changing the total weight percentages of the essential oils, specifically the total weight percentage of the combination of geranium oil, spearmint oil, and cinnamon oil, was also studied. The total essential oil percentage was varied between 0 and 100%, where the percentages of the three oils relative to one another were equal in each case, yet each oil varied between 0 and 33%. The Formulations 13-19 were prepared according to the weight percentages shown in Tables 8 and 9.

As shown in Table 8, Formulation 13 included 50 wt. % essential oil, Formulation 14 included 25 wt. % essential oil, and Formulation 15 included 10 wt. % essential oil.

TABLE 8
Components of Formulations 13-15.

| | Formu- | Formu- | Formu- |
|---|---|---|---|
| | lation | lation | lation |
| | 13 | 14 | 15 |
| Ingredient | (wt. %) | (wt. %) | (wt. %) |
| Geranium Oil | 16.67% | 8.33% | 3.33% |
| Spearmint Oil | 16.67% | 8.33% | 3.33% |
| Cinnamon Oil | 16.67% | 8.33% | 3.33% |
| Butyl Lactate | 5.26% | 7.89% | 9.47% |
| Isopropyl Myristate | 5.26% | 7.89% | 9.47% |
| Mineral Oil | 39.47% | 59.21% | 71.05% |

As shown in Table 9, Formulation 16 included 0.5 wt. % essential oil, Formulation 17 included 0.021 wt. % essential oil, Formulation 18 included 0.001 wt. % essential oil, and Formulation 19 included 0.0 wt. % essential oil.

TABLE 9
Components of Formulations 16-19.

| | Formu- | Formu- | Formu- | Formu- |
|---|---|---|---|---|
| | lation | lation | lation | lation |
| | 16 | 17 | 18 | 19 |
| Ingredient | (wt. %) | (wt. %) | (wt. %) | (wt. %) |
| Geranium Oil | 0.1667% | 0.0007% | 0.0003% | 0.0% |
| Spearmint Oil | 0.1667% | 0.0007% | 0.0003% | 0.0% |
| Cinnamon Oil | 0.1667% | 0.0007% | 0.0003% | 0.0% |
| Butyl Lactate | 10.47% | 10.53% | 10.53% | 10.53% |
| Isopropyl Myristate | 10.47% | 10.53% | 10.53% | 10.53% |
| Mineral Oil | 78.55% | 78.95% | 78.95% | 78.95% |

The efficacy data, including the knockdown percentage (after 30 seconds) and mortality percentage (after 24 hours), was observed for one crawling insect (Blattella germanica). The results from the efficacy tests are provided in Table 10 below.

As shown in the efficacy data in Table 10, the formulations exhibited strong knockdown and strong mortality results when the total active component (i.e., the total essential oil percentage) was between a range of about 0.001 wt. % and about 50 wt. %. In particular, formulations having essential oils in weight percentages between about 0.001 wt. % and about 50 wt. % exhibited 24-hour mean mortality of about 100% and 30-second knockdown of about 100%.

TABLE 10
Efficacy Data for Formulations 13-19.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 13 | 100% | 100% |
| 14 | 100% | 100% |
| 15 | 100% | 100% |
| 16 | 100% | 100% |
| 17 | 100% | 100% |
| 18 | 100% | 100% |
| 19 | 20% | 70% |

### Example 4

The effect of changing the total weight percent of essential oils used in the formulations or compositions was also studied using only geranium oil and spearmint oil. Here, Formulations 20-24 were prepared according to the weight percentages shown in Tables 11 and 12 using geranium oil and spearmint oil ranging from 0.001% to 25% total oil. The balance of the formulation is made up of mineral oil and equal percentages butyl lactate and isopropyl myristate.

As shown in Table 11, Formulation 20 included 25 wt. % total essential oil, Formulation 21 included 10 wt. % total essential oil, and Formulation 22 included 5.0 wt. % total essential oil.

TABLE 11
Components of Formulations 20-22.

| | Formu- | Formu- | Formu- |
|---|---|---|---|
| | lation | lation | lation |
| | 20 | 21 | 22 |
| Ingredient | (wt. %) | (wt. %) | (wt. %) |
| Geranium Oil | 12.5% | 5.00% | 2.50% |
| Spearmint Oil | 12.5% | 5.00% | 2.50% |
| Cinnamon Oil | 0% | 0% | 0% |
| Butyl Lactate | 7.89% | 9.47% | 10.00% |
| Isopropyl Myristate | 7.89% | 9.47% | 10.00% |
| Mineral Oil | 59.21% | 71.05% | 75.00% |

As shown in Table 12, Formulation 23 included 0.011 wt. % total essential oil, and Formulation 24 included 0.001 wt. % total essential oil.

TABLE 12
Components of Formulations 23-24.

| | Formu- | Formu- |
|---|---|---|
| | lation | lation |
| | 23 | 24 |
| Ingredient | (wt. %) | (wt. %) |
| Geranium Oil | 0.0055% | 0.0005% |
| Spearmint Oil | 0.0055% | 0.0005% |
| Cinnamon Oil | 0% | 0% |
| Butyl Lactate | 10.53% | 10.53% |
| Isopropyl Myristate | 10.53% | 10.53% |
| Mineral Oil | 78.94% | 78.95% |

The effect of changing the total weight percent of essential oil used in the formulations or compositions was also studied using only geranium oil and cinnamon oil. Here, Formulations 25-30 were prepared according to the weight percentages shown in Tables 13 and 14 using geranium oil and cinnamon oil ranging from 0.001% oil to 75% oil. The balance of the formulation is made up of mineral oil and equal percentages butyl lactate and isopropyl myristate.

As shown in Table 13, Formulation 25 included 75 wt. % total essential oil, Formulation 26 included 30 wt. % total essential oil, and Formulation 27 included 15 wt. % total essential oil.

TABLE 13
Components of Formulations 25-27.

| | Formu- | Formu- | Formu- |
|---|---|---|---|
| | lation | lation | lation |
| | 25 | 26 | 27 |
| Ingredient | (wt. %) | (wt. %) | (wt. %) |
| Geranium Oil | 37.5% | 15.0% | 7.50% |
| Spearmint Oil | 0% | 0% | 0% |
| Cinnamon Oil | 37.5% | 15.0% | 7.50% |
| Butyl Lactate | 2.63% | 7.37% | 8.95% |
| Isopropyl Myristate | 2.63% | 7.37% | 8.95% |
| Mineral Oil | 19.74% | 55.26% | 67.11% |

As shown in Table 14, Formulation 28 included 7.5 wt. % total essential oil, Formulation 29 included 0.011 wt. % total essential oil, and Formulation 30 included 0.001 wt. % total essential oil.

TABLE 14
Components of Formulations 28-30.

| | Formu- | Formu- | Formu- |
|---|---|---|---|
| | lation | lation | lation |
| | 28 | 29 | 30 |
| Ingredient | (wt. %) | (wt. %) | (wt. %) |
| Geranium Oil | 3.75% | 0.0055% | 0.0005% |
| Spearmint Oil | 0% | 0% | 0% |
| Cinnamon Oil | 3.75% | 0.0055% | 0.0005% |
| Butyl Lactate | 9.74% | 10.53% | 10.53% |
| Isopropyl Myristate | 9.74% | 10.53% | 10.53% |
| Mineral Oil | 73.03% | 78.94% | 78.95% |

The effect of changing the total weight percentage of essential oil used in the formulations or compositions was also studied using only spearmint oil and cinnamon oil. Here, Formulations 31-35 were prepared according to the weight percentages shown in Tables 15 and 16 using spearmint oil and cinnamon oil ranging from 0.001% oil to 30% oil. The balance of the formulation is made up of mineral oil and equal percentages butyl lactate and isopropyl myristate.

As shown in Table 15, Formulation 31 included 30 wt. % total essential oil, Formulation 32 included 15 wt. % total essential oil, and Formulation 34 included 7.5 wt. % total essential oil.

TABLE 15
Components of Formulations 31-33.

| | Formu- | Formu- | Formu- |
|---|---|---|---|
| | lation | lation | lation |
| | 31 | 32 | 33 |
| Ingredient | (wt. %) | (wt. %) | (wt. %) |
| Geranium Oil | 0% | 0% | 0% |
| Spearmint Oil | 15.0% | 7.50% | 3.75% |
| Cinnamon Oil | 15.0% | 7.50% | 3.75% |
| Butyl Lactate | 7.37% | 8.95% | 9.74% |
| Isopropyl Myristate | 7.37% | 8.95% | 9.74% |
| Mineral Oil | 55.26% | 67.11% | 73.03% |

As shown in Table 16, Formulation 34 included 0.011 wt. % total essential oil, and Formulation 35 included 0.001 wt. % total essential oil.

TABLE 16
Components of Formulations 34-35.

| | Formu- | Formu- |
|---|---|---|
| | lation | lation |
| | 34 | 35 |
| Ingredient | (wt. %) | (wt. %) |
| Geranium Oil | 0% | 0% |
| Spearmint Oil | 0.0055% | 0.0005% |
| Cinnamon Oil | 0.0055% | 0.0005% |
| Butyl Lactate | 10.53% | 10.53% |
| Isopropyl Myristate | 10.53% | 10.53% |
| Mineral Oil | 78.94% | 78.95% |

The efficacy data, including the knockdown percentage (after 30 seconds) and mortality percentage (after 24 hours), was observed for one crawling insect (Blattella germanica). The results from the efficacy tests are provided in Table 17 below.

As shown in the efficacy data in Table 17, each concentration or weight percentage of the active component having at least one mint oil (i.e., spearmint oil, in this embodiment) and geranium oil exhibited strong knockdown and mortality rates. In particular, formulations having at least one mint oil and geranium oil exhibited 24-hour mean mortality of about 100% and 30-second knockdown of greater than 96%.

TABLE 17
Efficacy Data for Formulations 20-24.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 20 | 96.67% | 100% |
| 21 | 100% | 100% |
| 22 | 96.67% | 100% |
| 23 | 100% | 100% |
| 24 | 100% | 100% |

As shown in the efficacy data in Table 18, each concentration or weight percentage of the active component having at least geranium oil and another oil (i.e., cinnamon oil, in this embodiment) exhibited strong knockdown and mortality rates, especially in concentrations higher than 0.001%. In particular, formulations having at least geranium oil and another oil (e.g., cinnamon oil) exhibited 24-hour mean mortality of about 100% and 30-second knockdown of about 100%.

TABLE 18
Efficacy Data for Formulations 25-30.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 25 | 100% | 100% |
| 26 | 100% | 100% |
| 27 | 100% | 100% |
| 28 | 100% | 100% |
| 29 | 100% | 100% |
| 30 | 60% | 83.33% |

As shown in the efficacy data in Table 19, each concentration or weight percentage of the active component having at least one mint oil (i.e., spearmint oil, in this embodiment) and another oil (i.e., cinnamon oil) exhibited strong knockdown and mortality rates. In particular, formulations having at least one mint oil and another oil (i.e., cinnamon oil) exhibited 24-hour mean mortality of about 100% and 30-second knockdown of about 100%.

TABLE 19
Efficacy Data for Formulations 31-35.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 31 | 100% | 100% |
| 32 | 100% | 100% |
| 33 | 100% | 100% |
| 34 | 100% | 100% |
| 35 | 100% | 100% |

### Example 5

The effect of changing the type of oil was also studied using clove oil, elemi oil, castor oil, and geraniol. For this study and example, Formulations 36-39 were prepared each with a single oil at 5% as shown in Table 20. Other component percentages were kept constant, e.g., butyl lactate 10%, isopropyl myristate 10%, and mineral oil 75%. No spearmint oil, geranium oil, or cinnamon oil was used in this example.

As shown in Table 20, Formulation 36 included 5 wt. % clove oil, Formulation 37 included 5 wt. % elemi oil, Formulation 38 included 5 wt. % castor oil, and Formulation 39 included 5 wt. % geraniol.

TABLE 20
Components of Formulations 36-39.

| | Formu- | Formu- | Formu- | Formu- |
|---|---|---|---|---|
| | lation | lation | lation | lation |
| | 36 | 37 | 38 | 39 |
| Ingredient | (wt. %) | (wt. %) | (wt. %) | (wt. %) |
| Clove Oil | 5.0% | 0% | 0% | 0% |
| Elemi Oil | 0% | 5.0% | 0% | 0% |
| Castor Oil | 0% | 0% | 5.0% | 0% |
| Geraniol | 0% | 0% | 0% | 5.0% |
| Butyl Lactate | 10.0% | 10.0% | 10.0% | 10.0% |
| Isopropyl Myristate | 10.0% | 10.0% | 10.0% | 10.0% |
| Mineral Oil | 75.0% | 75.0% | 75.0% | 75.0% |

The efficacy data, including the knockdown percentage (after 30 seconds) and mortality percentage (after 24 hours), was observed for one crawling insect (Blattella germanica). The results from the efficacy tests are provided in Table 21 below.

As shown in the efficacy data in Table 21, formulations including other oils exhibited inferior 30-second and 24-hour mean mortality data compared to formulations prepared according to an embodiment of the present disclosure. For example, formulations including other oils exhibited 30-second knockdown values of less than 85%, while formulations of the present disclosure consistently exhibited 30-second knockdown values of greater than 96% and 24-mortality values of about 100%, as shown in Examples 1 and 2 of the present disclosure. As such, this example helps showcase the efficacy of formulations of the present disclosure compared to formulations having other oils and other formulations without an active component having the synergy effect of the combination of at least one mint oil, geranium oil, and/or another oil (e.g., cinnamon oil).

TABLE 21
Efficacy Data for Formulations 36-39.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 36 | 50% | 70% |
| 37 | 53.33% | 70% |
| 38 | 63.33% | 90% |
| 39 | 73.33% | 83.33% |

### Example 6

The effect of changing the weight percentage of solvent (e.g., isopropyl alcohol, butyl lactate) was also studied. For this study and example, Formulations 40-48 were prepared according to the weight percentages shown in Tables 22 and 23. To keep other variables constant, the weight percentage and ratio of the essential oils was kept constant, i.e., 1.67 wt. % geranium oil, 1.67 wt. % spearmint oil and 1.67 wt. % cinnamon oil.

As shown in Table 22, Formulation 40 included 0.1 wt. % isopropyl alcohol, Formulation 41 included 1.0 wt. % isopropyl alcohol, Formulation 42 include 5.0 wt. % isopropyl alcohol, Formulation 43 included 10.0% isopropyl alcohol, and Formulation 44 included 50.0 wt. % isopropyl alcohol.

TABLE 22
Components of Formulations 40-44.

| | Formu- | Formu- | Formu- | Formu- | Formu- |
|---|---|---|---|---|---|
| | lation | lation | lation | lation | lation |
| | 40 | 41 | 42 | 43 | 44 |
| Ingredient | (wt. %) | (wt. %) | (wt. %) | (wt. %) | (wt. %) |
| Geranium Oil | 1.67% | 1.67% | 1.67% | 1.67% | 1.67% |
| Spearmint Oil | 1.67% | 1.67% | 1.67% | 1.67% | 1.67% |
| Cinnamon Oil | 1.67% | 1.67% | 1.67% | 1.67% | 1.67% |
| Butyl Lactate | 0% | 0% | 0% | 0% | 0% |
| Isopropyl | 0.1% | 1.0% | 5.0% | 10.0% | 50.0% |
| Alcohol | | | | | |
| Mineral Oil | 94.9% | 94.0% | 90.0% | 85.0 | 45.0% |

As shown in Table 23, Formulation 45 included 0.1 wt. % butyl lactate, Formulation 46 included 5.00 wt. % butyl lactate, Formulation 47 included 10.00 wt. % butyl lactate, and Formulation 48 include 50.00 wt. % butyl lactate.

TABLE 23
Components of Formulations 45-48.

| | Formu- | Formu- | Formu- | Formu- |
|---|---|---|---|---|
| | lation | lation | lation | lation |
| | 45 | 46 | 47 | 48 |
| Ingredient | (wt. %) | (wt. %) | (wt. %) | (wt. %) |
| Geranium Oil | 1.67% | 1.67% | 1.67% | 1.67% |
| Spearmint Oil | 1.67% | 1.67% | 1.67% | 1.67% |
| Cinnamon Oil | 1.67% | 1.67% | 1.67% | 1.67% |
| Butyl Lactate | 0.1% | 5.0% | 10.0% | 50.0% |
| Isopropyl Alcohol | 0% | 0% | 0% | 0% |
| Mineral Oil | 94.9% | 90.0% | 85.0% | 45.0% |

The efficacy data, including the knockdown percentage (after 30 seconds) and mortality percentage (after 24 hours), was observed for one crawling insect (Blattella germanica). The results from the efficacy tests are provided in Table 24 below.

As shown in the efficacy data in Table 24, concentrations of solvent typically provided some knockdown and mortality effects. However, no correlation was found between the solvent and the concentration thereof, and the percent knockdown and mortality observed. As a result, the test results exhibit that the improved efficacy in knockdown and mortality of the formulations of the present disclosure is not simply attributable to solvents of the formulations (e.g., isopropanol or butyl lactate), but rather attributable to the synergy of the combination of essential oils and other active components present in formulations of the present disclosure.

TABLE 24
Efficacy Data for Formulations 40-48.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 40 | 53.33% | 100% |
| 41 | 50.00% | 100% |
| 42 | 63.33% | 100% |
| 43 | 46.67% | 100% |
| 44 | 56.67% | 100% |
| 45 | 56.67% | 100% |
| 46 | 63.33% | 100% |
| 47 | 76.67% | 100% |
| 48 | 63.33% | 100% |

### Example 7

The effect of changing the weight percentage of the carrier was also studied. For this study and example, Formulations 49-53 were prepared with mineral oil as the carrier according to the weight percentages shown in Table 24. To keep other variables constant, the weight percentage and ratio of the essential oils was kept constant, i.e., 1.67 wt. % geranium oil, 1.67 wt. % spearmint oil, and 1.67 wt. % cinnamon oil.

As shown in Table 25, Formulation 49 included 0 wt. % mineral oil, Formulation 50 included 30 wt. % mineral oil, Formulation 51 included 60 wt. % mineral oil, Formulation 52 included 90 wt. % mineral oil, and Formulation 53 included 100 wt. % mineral oil.

TABLE 25
Components of Formulations 49-53.

| | Formu- | Formu- | Formu- | Formu- | Formu- |
|---|---|---|---|---|---|
| | lation | lation | lation | lation | lation |
| | 49 | 50 | 51 | 52 | 53 |
| Ingredient | (wt. %) | (wt. %) | (wt. %) | (wt. %) | (wt. %) |
| Geranium Oil | 1.67% | 1.67% | 1.67% | 1.67% | 0% |
| Spearmint Oil | 1.67% | 1.67% | 1.67% | 1.67% | 0% |
| Cinnamon Oil | 1.67% | 1.67% | 1.67% | 1.67% | 0% |
| Butyl Lactate | 47.5% | 32.5% | 17.5% | 2.50% | 0% |
| Isopropyl | 47.5% | 32.5% | 17.5% | 2.50% | 0% |
| Alcohol | | | | | |
| Mineral Oil | 0% | 30.0% | 60.0% | 90.0% | 100.0% |

The efficacy data, including the knockdown percentage (after 30 seconds) and mortality percentage (after 24 hours), was observed for one crawling insect (Blattella germanica). The results from the efficacy tests are provided in Table 26 below.

As shown in the efficacy data in Table 26, mineral oil itself typically provided some knockdown and mortality effects. However, an inverse relationship (if any relationship) was found between the carrier and the concentration thereof, and the percent knockdown and mortality observed. As a result, the test results exhibit that the improved efficacy in knockdown and mortality of the formulations of the present disclosure is not attributable to carriers of the formulations (e.g., mineral oil), but rather attributable to the synergy of the combination of essential oils and other active components present in formulations of the present disclosure.

TABLE 26
Efficacy Data for Formulations 49-53.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 49 | 63.33% | 100% |
| 50 | 60.00% | 100% |
| 51 | 40.00% | 76.67% |
| 52 | 46.67% | 76.67% |
| 53 | 0.00% | 60.00% |

### Example 8

The effect of changing the weight percentage of the dehydrate was also studied. For this study and example, Formulations 54-58 were prepared with isopropyl myristate according to the weight percentages shown in Tables 27. To keep other variables constant, the weight percentage and ratio of the essential oils was kept constant, i.e., 1.67 wt. % geranium oil, 1.67 wt. % spearmint oil, and 1.67 wt. % cinnamon oil.

As shown in Table 27, Formulation 54 included 0 wt. % isopropyl myristate, Formulation 55 included 30 wt. % isopropyl myristate, Formulation 56 included 7.5 wt. % isopropyl myristate, Formulation 57 included 10 wt. % isopropyl myristate, and Formulation 58 included 30 wt. % isopropyl myristate.

TABLE 27
Components of Formulations 54-58.

| | Formu- | Formu- | Formu- | Formu- | Formu- |
|---|---|---|---|---|---|
| | lation | lation | lation | lation | lation |
| | 54 | 55 | 56 | 57 | 58 |
| Ingredient | (wt. %) | (wt. %) | (wt. %) | (wt. %) | (wt. %) |
| Geranium Oil | 1.67% | 1.67% | 1.67% | 1.67% | 1.67% |
| Spearmint Oil | 1.67% | 1.67% | 1.67% | 1.67% | 1.67% |
| Cinnamon Oil | 1.67% | 1.67% | 1.67% | 1.67% | 1.67% |
| Isopropyl | 0.1% | 1.0% | 7.5% | 10.0% | 30.0% |
| Myristate | | | | | |
| Mineral Oil | 94.9% | 94.0% | 87.5% | 85.0% | 65.0% |

The efficacy data, including the knockdown percentage (after 30 seconds) and mortality percentage (after 24 hours), was observed for one crawling insect (Blattella germanica). The results from the efficacy tests are provided in Table 28 below.

As shown in the efficacy data in Table 28, a dehydrate (such as isopropyl myristate) itself typically provided some knockdown and mortality effects. In addition, overall higher concentrations of the dehydrate typically coincided with higher efficacy values. However, many of the formulations of the present disclosure included dehydrates in concentrations lower than the high percentage concentrations tested in this example. Further, the percent knockdown and mortality data for formulations of the present disclosure are superior to those having high concentrations of the dehydrate. As a result, the test results exhibit that the improved efficacy in knockdown and mortality of the formulations of the present disclosure is not simply attributable to a dehydrate of the formulations (e.g., isopropyl myristate), but rather attributable to the synergy of the combination of essential oils and other active components present in formulations of the present disclosure.

TABLE 28
Efficacy Data for Formulations 54-58.

| | German | German |
|---|---|---|
| | cockroach | cockroach |
| | (Blattella | (Blattella |
| | germanica) | germanica) |
| | mean % | mean % |
| | knockdown 30 | mortality 24 |
| Formulation | seconds | hours |
| 54 | 23.33% | 53.33% |
| 55 | 23.33% | 50.00% |
| 56 | 16.67% | 50.00% |
| 57 | 43.33% | 73.33% |
| 58 | 40.00% | 76.67% |

### Example 9

The effect of changing the weight percentage and type of the propellant was also studied. For this study and example, Formulations 59-63 were prepared according to the weight percentages shown in Tables 29 and 30. To keep other variables constant, the weight percentage and ratio of the essential oils was kept constant, i.e., 1.67 wt. % geranium oil, 1.67 wt. % spearmint oil, and 1.67 wt. % cinnamon oil. Mineral oil was used as the carrier in various percentages to make up the balance of the weight.

As shown in Table 29, Formulation 59 included 0.01 wt. % liquid petroleum gas (LPG), Formulation 60 included 1.0 wt. % LPG, and Formulation 61 included 3.0 wt. % LPG.

TABLE 29
Components of Formulations 59-61.

| | Formu- | Formu- | Formu- |
|---|---|---|---|
| | lation | lation | lation |
| | 59 | 60 | 61 |
| Ingredient | (wt. %) | (wt. %) | (wt. %) |
| Geranium Oil | 1.67% | 1.67% | 1.67% |
| Spearmint Oil | 1.67% | 1.67% | 1.67% |
| Cinnamon Oil | 1.67% | 1.67% | 1.67% |
| LPG | 0.01% | 1.0% | 3.0% |
| Mineral Oil | 94.9% | 94.0% | 92.0% |

As shown in Table 30, Formulation 62 included 5.0 wt. % LPG, and Formulation 63 included 10.0 wt. % LPG.

TABLE 30
Components of Formulations 62 and 63.

| | Formu- | Formu- |
|---|---|---|
| | lation | lation |
| | 62 | 63 |
| Ingredient | (wt. %) | (wt. %) |
| Geranium Oil | 1.67% | 1.67% |
| Spearmint Oil | 1.67% | 1.67% |
| Cinnamon Oil | 1.67% | 1.67% |
| LPG | 5.0% | 10.0% |
| Mineral Oil | 85.0% | 85.0% |

The efficacy data, including the knockdown percentage (after 30 seconds) and mortality percentage (after 24 hours), was observed for one crawling insect (Blattella germanica). The results from the efficacy tests are provided in Table 31 below.

As shown in the efficacy data in Table 31, the testing results showcase optimal propellant amounts that may be used in combination with the formulations of the present disclosure, if an aerosol formulation is desired. Although this testing was only performed for LPG, it should be understood that other propellants, including but not limited to, carbon dioxide and nitrogen, for example, may also be used in combination with the formulations of the present disclosure.

TABLE 31
Efficacy Data for Formulations 59-63.

| | German | German |
|---|---|---|
| | cockroach | cockroach |
| | (Blattella | (Blattella |
| | germanica) | germanica) |
| | mean % | mean % |
| | knockdown | mortality 24 |
| Formulation | 30 seconds | hours |
| 61 | 100% | 100% |
| 62 | 100% | 100% |
| 63 | 100% | 100% |

The various methods and techniques described above provide a number of ways to carry out embodiments of the present disclosure. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the at least two active ingredients selected for the pest control composition, the target pest, and the amounts of the various ingredients present in the pest control composition. Various embodiments of the invention can specifically include or exclude any of these variations or elements.

In some embodiments, the numbers expressing quantities of ingredients, properties such as weight percentages, percent repellency, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the present disclosure (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Particular embodiments of the present disclosure are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

It is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/We claim:

1. A pest control composition, the composition comprising:
an active component consisting essentially of:
a) between about 0.001 wt. % to about 5 wt. % spearmint oil;
b) between about 0.01 wt. % to about 5 wt. % geranium oil; and
c) between about 0 wt. % to about 5 wt. % of a third oil selected from the group consisting of cinnamon oil, cedarwood oil, and mixtures thereof;
a carrier;
a solvent; and
a dehydrate,
wherein all weight percentages are percent by weight of the total composition.

2. The composition of claim 1, wherein the active component is between about 2 wt. % and about 6 wt. %.

3. The composition of claim 1, wherein the spearmint oil is between about 0.05 wt. % and about 2 wt. %, the geranium oil is between about 0.05 wt. % and about 2 wt. %, and the third oil is between about 0.05 wt. % and about 2 wt. %.

4. The composition of claim 1, wherein the weight ratio of geranium oil to spearmint oil is from about 0.5:1 to about 20:1.

5. The composition of claim 1, wherein the solvent is selected from the group consisting of ethyl lactate, butyl lactate, isopropyl alcohol, and any combinations thereof.

6. The composition of claim 1, wherein the carrier is selected from the group consisting of aliphatic C₉-C₁₄ hydrocarbons, alicyclic C₉-C₁₄ hydrocarbons, naphtha, petroleum distillate, paraffins, iso-paraffins, isoparaffinic hydrocarbons, cycloparaffins, alkanes, iso-alkanes, cycloalkanes, mineral oil, white mineral oil, and any combinations thereof.

7. The composition of claim 1, wherein the dehydrate is isopropyl myristate.

8. The composition of claim 1, wherein the composition comprises between about 8 wt. % and about 15 wt. % by weight of the dehydrate; between about 1 wt. % and about 5 wt. % of a propellant; between about 60 wt. % and about 90 wt. % of the carrier; and between about 1 wt. % and about 10 wt. % of the solvent.

9. The composition of claim 8, wherein the propellant is selected from the group consisting of compressed gas propellants, liquefied gas propellants, saturated hydrocarbons, mixtures of liquified gas and compressed gas, methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof.

10. The composition of claim 1, wherein the spearmint oil is in a higher weight percentage concentration than the geranium oil.

11. A pest control composition, the composition comprising:
an active component consisting essentially of:
a) between about 0.01 wt. % to about 5 wt. % geranium oil;
b) between about 0.001 wt. % to about 5 wt. % of at least one mint oil; and
c) between about 0 wt. % to about 5 wt. % of a third oil selected from the group consisting of cinnamon oil, cedarwood oil, and mixtures thereof;
a carrier;
a solvent; and
a dehydrate,
wherein all weight percentages are percent by weight of the total composition.

12. The composition of claim 11, wherein the mint oil is selected from the group consisting of spearmint oil, peppermint oil, cornmint oil, and mixtures thereof.

13. The composition of claim 12, wherein the composition comprises between about 8 wt. % and about 15 wt. % by weight of the dehydrate; between about 1 wt. % and about 5 wt. % of a propellant; between about 60 wt. % and about 90 wt. % of the carrier; and between about 1 wt. % and about 10 wt. % of the solvent.

14. The composition of claim 12, wherein the weight ratio of geranium oil to mint oil is from about 0.5:1 to about 20:1.

15. The composition of claim 12, wherein the carrier is selected from the group consisting of aliphatic C₉-C₁₄ hydrocarbons, alicyclic C₉-C₁₄ hydrocarbons, naphtha, petroleum distillate, paraffins, iso-paraffins, isoparaffinic hydrocarbons, cycloparaffins, alkanes, iso-alkanes, cycloalkanes, mineral oil, white mineral oil, and any combinations thereof.

16. The composition of claim 13, wherein the solvent is selected from the group consisting of ethyl lactate, butyl lactate, isopropyl alcohol, and any combinations thereof.

17. The composition of claim 16, wherein the dehydrate is isopropyl myristate.

18. The composition of claim 11, wherein the mint oil is spearmint oil.

19. The composition of claim 15, wherein the propellant is selected from the group consisting of compressed gas propellants, liquefied gas propellants, saturated hydrocarbons, mixtures of liquid gas and compressed gas, methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof.

20. A pest control composition comprising:
an active component comprising:
a) between about 0.001 wt. % and about 5 wt. % of a mint oil selected from the group consisting of spearmint oil, cornmint oil, and mixtures thereof;
b) between about 0.01 wt. % and about 5 wt. % geranium oil; and
c) between about 0 wt. % to about 5 wt. % of a third oil selected from the group consisting of cinnamon oil, cedarwood oil, and mixtures thereof;
about 60 wt. % to about 90 wt. % of mineral oil;
about 2 wt. % to about 10 wt. % at least one solvent;
about 8 wt. % to about 15 wt. % of at least one dehydrate; and
about 1 wt. % to about 5 wt. % of at least one propellant,
wherein a weight ratio of geranium oil to mint oil is from about 0.5:1 to about 20:1,
wherein all weight percentages are percent by weight of the total composition.
